(19) United States
(12) Patent Application Publication
(10) Pub. No.: US 2026/0071734 A1
(43) Pub. Date: Mar. 12, 2026

(54) LIGHT EMITTING DEVICE AND ILLUMINATION DEVICE

(71) Applicant: NICHIA CORPORATION, Anan-shi (JP)

(72) Inventors: Kazushige FUJIO, Tokushima-shi (JP); Mika Matsumoto, Itano-gun (JP)

(73) Assignee: NICHIA CORPORATION, Anan-shi (JP)

(21) Appl. No.: 18/852,705

(22) PCT Filed: Feb. 15, 2023
(86) PCT No.: PCT/JP2023/005107

§ 371 Date: May 21, 2025

(30) Foreign Application Priority Data
Mar. 31, 2022 (JP) 2022-057990
Feb. 2, 2023 (JP) 2023-014610

(51) Int. Cl. F21V 9/38; F21Y 113/20

(52) U.S. Cl. CPC F21V 9/38; F21Y 2113/20

(57) ABSTRACT

A light emitting device includes a light emitting element having a light emission peak wavelength of 430 nm or more and 470 nm or less, and a fluorescent member containing a first fluorescent material having a light emission peak wavelength of 510 nm or more and less than 590 nm and a second fluorescent material having a light emission peak wavelength of 590 nm or more and 670 nm or less and containing a first fluoride fluorescent material having a composition included in the compositional formula represented by the following formula (1):

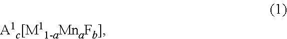

where A¹ includes K, M¹ includes Si and Al, a and b satisfy 0<a<0.2 and 5<b<7, and c represents the absolute value of the charge of [M¹₁₋ₐMnₐF_{b}] ions.

The light emitting device satisfies the following condition (A) or (B):
the condition (A) is that an average color rendering index Ra is 80 or more and 90 or less and a color rendering index R9 is 50 or more and 90 or less; and
the condition (B) is that an average color rendering index Ra is 80 or more and 87 or less and a color rendering index R9 is 50 or more.

### TECHNICAL FIELD

The present invention relates to a light emitting device and an illumination device.

### BACKGROUND ART

There are light emitting devices that use a light emitting element such as a light emitting diode (LED), including those that use a blue-light emitting LED in combination with a fluorescent material. Such light emitting devices are used in general lighting, on-vehicle lighting, displays, and backlighting for liquid crystal display devices.

The light emitting devices may be required to have a high average color rendering index Ra, which is an index of how the color of an irradiated object appears (color rendering property), and a high luminous flux.

For an evaluation process for the color rendering property of a light source, Japanese Industrial Standard (JIS) Z8726 specifies that test colors (R1 to R15) having predetermined reflectance characteristics are colorimetrically measured for each test light source and reference light source, and the color difference ΔEi (where i is an integer of 1 to 15) is numerically calculated to determine a color rendering index Ri. The upper limit of each color rendering index Ri (where i is an integer of 1 to 15) is 100. The smaller the color difference between a test light source and a reference light source with a color temperature corresponding to the test light source, the higher the color rendering index, which approaches 100.

In relation with the above, light emitting devices using a blue-light emitting LED and a fluorescent material have been proposed to achieve a high degree of color reproducibility (see, for example, Patent Literature 1).

### CITATION LIST

### Patent Literature

Patent Literature 1: Japanese Translation of PCT International Application Publication No. 2003-535477

### SUMMARY OF THE INVENTION

### Problem to be Solved by the Invention

When an average color rendering index Ra is to be increased, a luminous flux of the light emitting device may decrease. The light emitting devices using an LED may be required to have not only a high average color rendering index Ra, but also a high specific color rendering index, such as R9 or R15, and a high luminous flux.

One aspect of the present invention has an object to provide a light emitting device and an illumination device having a high color rendering index and a high luminous flux.

### Means for Solving Problem

A first aspect of the present disclosure is a light emitting device including a light emitting element having a light emission peak wavelength of 430 nm or more and 470 nm or less, and a fluorescent member containing a first fluorescent material having a light emission peak wavelength of 510 nm or more and less than 590 nm and a second fluorescent material having a light emission peak wavelength of 590 nm or more and 670 nm or less and containing a first fluoride fluorescent material having a composition included in the compositional formula represented by the following formula (1):

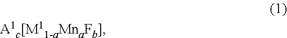

wherein A¹ includes at least K and optionally at least one element selected from the group consisting of Li, Na, Rb, and Cs, M¹ includes at least Si and Al and optionally at least one element selected from the group consisting of Group 4 elements, Group 13 elements, and Group 14 elements, a and b satisfy 0<a<0.2 and 5<b<7, and c represents the absolute value of the charge of [M¹₁₋ₐMnₐF_{b}] ions, and
wherein the light emitting device satisfies the following condition (A) or (B):
   the condition (A) is that an average color rendering index Ra of light emitted from the light emitting device is 80 or more and 90 or less, and a color rendering index R9 thereof is 50 or more and 90 or less; and
   the condition (B) is that an average color rendering index Ra of light emitted from the light emitting device is 80 or more and 87 or less, and a color rendering index R9 thereof is 50 or more.

A second aspect of the present disclosure is a light emitting device including a light emitting element having a light emission peak wavelength of 430 nm or more and 470 nm or less, and a fluorescent member containing a first fluorescent material having a light emission peak wavelength of 510 nm or more and less than 590 nm, a second fluorescent material having a light emission peak wavelength of 590 nm or more and 670 nm or less and containing at least one fluoride fluorescent material selected from the group consisting of a first fluoride fluorescent material having a composition included in the compositional formula represented by the following formula (1) and a second fluoride fluorescent material having a composition included in the compositional formula represented by the following formula (2), and a third fluorescent material containing at least one nitride fluorescent material selected from the group consisting of a first nitride fluorescent material having a composition included in the compositional formula represented by the following formula (3) and a second nitride fluorescent material having a composition included in the compositional formula represented by the following formula (4):

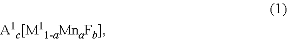

wherein A¹ includes at least K and optionally at least one element selected from the group consisting of Li, Na, Rb, and Cs, M¹ includes at least Si and Al and optionally at least one element selected from the group consisting of Group 4 elements, Group 13 elements, and Group 14 elements, a and b satisfy 0<a<0.2 and 5<b<7, and c represents the absolute value of the charge of [M¹₁₋ₐMnₐF_{b}] ions;

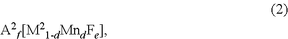

wherein A² includes at least one element selected from the group consisting of Li, Na, K, Rb, and Cs, M² includes at least one of Si and Ge and optionally at least one element selected from the group consisting of Group 4 elements and Group 14 elements, d and e satisfy 0<d<0.2 and 5<e<7, and f represents the absolute value of the charge of [M²₁₋ₐMn_{d}Fₑ] ions;

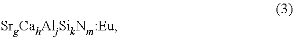

wherein g, h, j, k, and m satisfy 0≤g≤1, 0<h≤1, g+h≤1, 0.9≤j≤1.1, 0.9≤k≤1.1, and 2.5≤m≤3.5; and

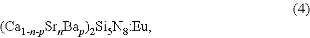

wherein n and p satisfy 0≤n≤1.0 and 0≤p≤1.0, and
wherein the light emitting device satisfies the following condition (C):
   the condition (C) is that an average color rendering index Ra of light emitted from the light emitting device is 80 or more and 90 or less, and a special color rendering index R9 thereof is 50 or more.

A third aspect of the present disclosure relates to a light emitting device including a light emitting element having a light emission peak wavelength of 430 nm or more and 470 nm or less, and a fluorescent member containing a first fluorescent material having a light emission peak wavelength of 510 nm or more and less than 590 nm and a second fluorescent material having a light emission peak wavelength of 590 nm or more and 670 nm or less and containing a second fluoride fluorescent material having a composition included in the compositional formula represented by the following formula (2):

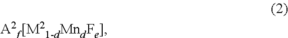

wherein A² includes at least one element selected from the group consisting of Li, Na, K, Rb, and Cs, M² includes at least one of Si and Ge and optionally at least one element selected from the group consisting of Group 4 elements and Group 14 elements, d and e satisfy 0<d<0.2 and 5<e<7, and f represents the absolute value of the charge of [M²_{1-d}Mn_{d}Fₑ] ions,
wherein the light emitting device satisfies the following condition (A′) or (B):
   the condition (A′) is that an average color rendering index Ra of light emitted from the light emitting device is 80 or more, and a color rendering index R9 thereof is 50 or more and 70 or less; and
   the condition (B) is that an average color rendering index Ra of light emitted from the light emitting device is 80 or more and 87 or less, and a special color rendering index R9 thereof is 50 or more, and
wherein the light emitting device has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi):
(i) when the correlated color temperature is 2,000 K or more and less than 2,800 K, the first light emission intensity ratio I₅₀₀ is 0.01 or more and 0.15 or less;
(ii) when the correlated color temperature is 2,800 K or more and less than 3,300 K, the first light emission intensity ratio I₅₀₀ is 0.01 or more and 0.35 or less;
(iii) when the correlated color temperature is 3,300 K or more and less than 3,700 K, the first light emission intensity ratio I₅₀₀ is 0.01 or more and 0.45 or less;
(iv) when the correlated color temperature is 3,700 K or more and less than 4,500 K, the first light emission intensity ratio I₅₀₀ is 0.01 or more and 0.50 or less;
(v) when the correlated color temperature is 4,500 K or more and less than 5,700 K, the first light emission intensity ratio I₅₀₀ is 0.01 or more and 0.55 or less; and
(vi) when the correlated color temperature is 5,700 K or more and 6,800 K or less, the first light emission intensity ratio I₅₀₀ is 0.01 or more and 0.70 or less.

A fourth aspect of the present disclosure relates to an illumination device including the light emitting device.

### Effect of the Invention

According to one aspect of the present invention, a light emitting device and an illumination device having a high color rendering index and a high luminous flux can be provided.

### BRIEF DESCRIPTION OF DRAWINGS

FIG. 1 is a schematic cross-sectional view of an exemplary light emitting device.

FIG. 2 is a graph showing light emission spectra of the light emitting devices according to Example 1 and Comparative Examples 1 and 2, and a spectral luminous efficiency curve V (λ) for photopic vision of humans.

FIG. 3 is a graph showing light emission spectra of the light emitting devices according to Example 2 and Comparative Examples 1 and 2, and a spectral luminous efficiency curve V (λ) for photopic vision of humans.

FIG. 4 is a graph showing light emission spectra of the light emitting devices according to Example 14 and Comparative Examples 1 and 2, and a spectral luminous efficiency curve V (λ) for photopic vision of humans.

FIG. 5 is a graph showing light emission spectra of the light emitting devices according to Example 3 and Comparative Examples 3 and 4, and a spectral luminous efficiency curve V (λ) for photopic vision of humans.

FIG. 6 is a graph showing light emission spectra of the light emitting devices according to Example 4 and Comparative Examples 3 and 4, and a spectral luminous efficiency curve V (λ) for photopic vision of humans.

FIG. 7 is a graph showing light emission spectra of the light emitting devices according to Example 5 and Comparative Examples 3 and 4, and a spectral luminous efficiency curve V (λ) for photopic vision of humans.

FIG. 8 is a graph showing light emission spectra of the light emitting devices according to Example 6 and Comparative Examples 5 and 6, and a spectral luminous efficiency curve V (λ) for photopic vision of humans.

FIG. 9 is a graph showing light emission spectra of the light emitting devices according to Example 7 and Comparative Examples 5 and 6, and a spectral luminous efficiency curve V (λ) for photopic vision of humans.

FIG. 10 is a graph showing light emission spectra of the light emitting devices according to Example 8 and Comparative Examples 7 and 8, and a spectral luminous efficiency curve V (λ) for photopic vision of humans.

FIG. 11 is a graph showing light emission spectra of the light emitting devices according to Example 9 and Comparative Examples 7 and 8, and a spectral luminous efficiency curve V (λ) for photopic vision of humans.

FIG. 12 is a graph showing light emission spectra of the light emitting devices according to Example 10 and Comparative Examples 9 and 10, and a spectral luminous efficiency curve V (λ) for photopic vision of humans.

FIG. 13 is a graph showing light emission spectra of the light emitting devices according to Example 11 and Comparative Examples 9 and 10, and a spectral luminous efficiency curve V (λ) for photopic vision of humans.

FIG. 14 is a graph showing light emission spectra of the light emitting devices according to Example 12 and Comparative Examples 11 and 12, and a spectral luminous efficiency curve V (λ) for photopic vision of humans.

FIG. 15 is a graph showing light emission spectra of the light emitting devices according to Example 13 and Comparative Examples 11 and 12, and a spectral luminous efficiency curve V (λ) for photopic vision of humans.

FIG. 16 is a graph showing light emission spectra of the light emitting devices according to Example 15 and Comparative Examples 11 and 12, and a spectral luminous efficiency curve V (λ) for photopic vision of humans.

### MODE(S) FOR CARRYING OUT THE INVENTION

Embodiments of the present invention are hereinafter described with reference to the accompanying drawings. The embodiments described below are those that exemplify a light emitting device and an illumination device for the purpose of giving concrete form to the technical idea of the present invention, and the present invention is not limited to the following light emitting device and the illumination device. In addition, the members described in the claims are by no means limited to members of the embodiments. In particular, unless otherwise specified, the dimensions, materials, shapes, and relative arrangements of the structural members described in the embodiments are not intended to limit the scope of the present invention, but are merely illustrative examples. The relationships between color names and chromaticity coordinates, and the relationships between wavelength ranges of light and color names of monochromic light are in accordance with JIS Z8110. In the present specification, unless otherwise specified, in the case where a plurality of substances corresponding to each component are present in a composition, the content of each component in the composition means a total amount of the plurality of substances present in the composition. In the present specification, the full width at half maximum (FWHM) refers to a width of a wavelength at 50% intensity of the light emission intensity at the light emission peak wavelength, at which the maximum light emission intensity is exhibited, in the light emission spectrum.

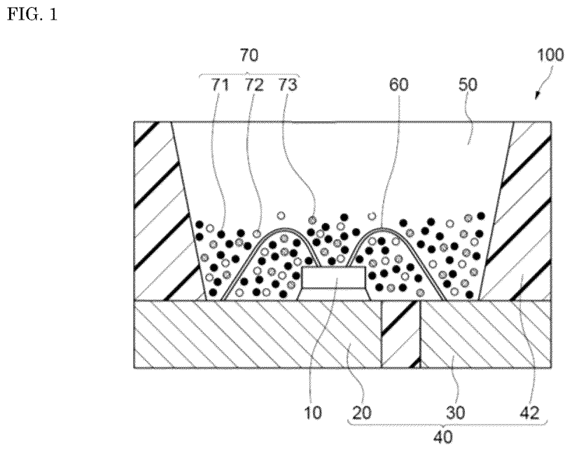

An example of the light emitting device is hereunder described with reference to the drawings. FIG. 1 is a schematic cross-sectional view of a light emitting device 100.

The light emitting device 100 includes a light emitting element 10 and a molded body 40 on which the light emitting element 10 is disposed. The molded body 40 is formed by integrally molding a first lead 20, a second lead 30, and a resin portion 42 containing a thermoplastic resin or a thermosetting resin. The molded body 40 has a recessed portion formed therein having a bottom surface and side surfaces, and the light emitting element 10 is disposed on the bottom surface of the recessed portion. The light emitting element 10 has a pair of positive and negative electrodes, and the pair of positive and negative electrodes are respectively electrically connected to the first lead 20 and the second lead 30 via wires 60. The light emitting element 10 is covered with a fluorescent member 50. For example, the fluorescent member 50 contains: as a fluorescent material 70 that converts the wavelength of light emitted from the light emitting element 10, at least one fluorescent material selected from the group consisting of a first fluorescent material 71, a second fluorescent material 72, and a third fluorescent material 73; and a resin.

The fluorescent member 50 not only converts the wavelength of the light emitted from the light emitting element 10, but also functions as a member for protecting the light emitting element 10 from the external environment. In FIG. 1, the fluorescent material 70 is unevenly distributed within the fluorescent member 50. By disposing the fluorescent material 70 close to the light emitting element 10 as shown in FIG. 1, the light emitted from the light emitting element 10 can be efficiently subjected to wavelength conversion. The disposition of the fluorescent member 50 containing the fluorescent material 70 and the light emitting element 10 is not limited to the configuration in which these members are disposed close to each other, and the fluorescent material 70 may be disposed, in the fluorescent member 50, apart from the light emitting element 10 in consideration of the influence of heat on the fluorescent material 70. Alternatively, the fluorescent material 70 may be mixed substantially uniformly over the fluorescent element 50 to obtain light with further reduced color unevenness. In FIG. 1, the fluorescent material 70 is composed of a first fluorescent material 71, a second fluorescent material 72, and a third fluorescent material 73 mixed together. Each of the first fluorescent material 71, the second fluorescent material 72, and the third fluorescent material 73 may be disposed in the form of a layer. For example, the third fluorescent material 73 may be disposed on the bottom surface of the recessed portion, the second fluorescent material 72 may be disposed on the third fluorescent material 73, and the first fluorescent material 71 may be further disposed thereon. Alternatively, the first fluorescent material 71 may be disposed on the third fluorescent material 73 and the second fluorescent material 72, or the fluorescent material 71, the second fluorescent material 72, and the third fluorescent material 73 may be disposed in any arrangement.

The light emitting device according to the first aspect includes a light emitting element having a light emission peak wavelength of 430 nm or more and 470 nm or less, and a fluorescent member containing a first fluorescent material having a light emission peak wavelength of 510 nm or more and less than 590 nm and a second fluorescent material having a light emission peak wavelength of 590 nm or more and 670 nm or less and containing a first fluoride fluorescent material having a composition included in the compositional formula represented by the following formula (1), wherein the light emitting device satisfies the following condition (A) or (B). The second fluorescent material may contain only a first fluoride fluorescent material having a composition included in the compositional formula represented by the following formula (1):

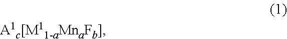

wherein A¹ includes at least K and optionally at least one element selected from the group consisting of Li, Na, Rb, and Cs, M¹ includes at least Si and Al and optionally at least one element selected from the group consisting of Group 4 elements, Group 13 elements, and Group 14 elements, a and b satisfy 0<a<0.2 and 5<b<7, and c represents the absolute value of the charge of [M¹₁₋ₐMnₐF_{b}] ions.
Condition (A): The average color rendering index Ra of light emitted from the light emitting device is 80 or more and 90 or less, and the color rendering index R9 thereof is 50 or more and 90 or less.
Condition (B): The average color rendering index Ra of light emitted from the light emitting device is 80 or more and 87 or less, and the color rendering index R9 thereof is 50 or more. In the condition (B) in the light emitting device according to the first aspect, the special color rendering index R9 may be 98 or less, may be 95 or less, or may be 90 or less.

In the formula (1) representing the composition of the first fluoride fluorescent material, A¹ includes at least K, and may further include at least one selected from the group consisting of Li, Na, Rb, and Cs. A¹ may be partially substituted with ammonium ions (NH₄⁺). When A¹ is partially substituted with ammonium ions, a ratio of the number of moles of ammonium ions to the total number of moles of A¹ in the composition may be, for example, 0.10 or less, preferably 0.05 or less or 0.03 or less. The lower limit of the ratio of the number of moles of ammonium ions may be, for example, more than 0, preferably 0.005 or more.

The light emitting device according to the second aspect includes a light emitting element having a light emission peak wavelength of 430 nm or more and 470 nm or less, and a fluorescent member containing a first fluorescent material having a light emission peak wavelength of 510 nm or more and less than 590 nm, a second fluorescent material having a light emission peak wavelength of 590 nm or more and 670 nm or less and containing at least one fluoride fluorescent material selected from the group consisting of a first fluoride fluorescent material having a composition included in the compositional formula represented by the formula (1) and a second fluoride fluorescent material having a composition included in the compositional formula represented by the following formula (2), and a third fluorescent material containing at least one nitride fluorescent material selected from the group consisting of a first nitride fluorescent material having a composition included in the compositional formula represented by the following formula (3) and a second nitride fluorescent material having a composition included in the compositional formula represented by the following formula (4), wherein the light emitting device satisfies the following condition (C):

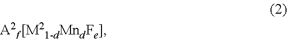

wherein A² includes at least one element selected from the group consisting of Li, Na, K, Rb, and Cs, M² includes at least one of Si and Ge and optionally at least one element selected from the group consisting of Group 4 elements and Group 14 elements, d and e satisfy 0<d<0.2 and 5<e<7, and f represents the absolute value of the charge of [M²_{1-d}Mn_{d}Fₑ] ions;

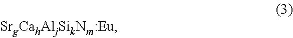

wherein g, h, j, k, and m satisfy 0≤g<1, 0<h≤1, g+h≤1, 0.9≤j≤1.1, 0.9≤k≤1.1, and 2.5≤m≤3.5; and

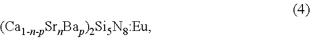

wherein n and p satisfy 0≤n≤1.0 and 0≤p≤1.0.
Condition (C): The average color rendering index Ra of light emitted from the light emitting device is 80 or more and 90 or less, and the special color rendering index thereof R9 is 50 or more. In the condition (C) in the light emitting device according to the second aspect, the special color rendering index R9 may be 98 or less, may be 95 or less, may be 90 or less, may be 85 or less, or may be 80 or less.

In the formula (2) representing the composition of the second fluoride fluorescent material, A² includes at least K, and may further include at least one selected from the group consisting of Li, Na, Rb, and Cs. A² may be partially substituted with ammonium ions (NH₄⁺). When A² is partially substituted with ammonium ions, a ratio of the number of moles of ammonium ions to the total number of moles of A² in the composition may be, for example, 0.10 or less, preferably 0.05 or less or 0.03 or less. The lower limit of the ratio of the number of moles of ammonium ions may be, for example, more than 0, preferably 0.005 or more. The second fluoride fluorescent material having a composition included in the compositional formula represented by the formula (2), preferably does not contain Group 13 elements in the composition to the extent expressed in the molar ratio in the compositional formula, more preferably does not contain Al in the composition to the extent expressed in the molar ratio in the compositional formula.

The third fluorescent material contains at least one nitride fluorescent material selected from the group consisting of a first nitride fluorescent material having a composition included in the compositional formula represented by the formula (3) and a second nitride fluorescent material having a composition included in the compositional formula represented by the formula (4).

The first nitride fluorescent material preferably has a light emission peak wavelength of 590 nm or more and 670 nm or less, more preferably 600 nm or more and 650 nm or less, and even more preferably 600 nm or more and 640 nm or less. The first nitride fluorescent material preferably has a full width at half maximum of 60 nm or more and 100 nm or less, more preferably 65 nm or more and 90 nm or less, and even more preferably 70 nm or more and 80 nm or less.

The second nitride fluorescent material preferably has a light emission peak wavelength of 590 nm or more and 630 nm or less, more preferably 590 nm or more and 625 nm or less, and even more preferably 590 nm or more and 620 nm or less. The second nitride fluorescent material preferably has a full width at half maximum of 70 nm or more and 100 nm or less, more preferably 75 nm or more and 95 nm or less, and even more preferably 80 nm or more and 90 nm or less.

The light emitting device according to the third aspect includes a light emitting element having a light emission peak wavelength of 430 nm or more and 470 nm or less, and a fluorescent member containing a first fluorescent material having a light emission peak wavelength of 510 nm or more and less than 590 nm and a second fluorescent material having a light emission peak wavelength of 590 nm or more and 670 nm or less and containing a second fluoride fluorescent material having a composition included in the compositional formula represented by the formula (2), wherein the light emitting device satisfies the following condition (A′) or (B), and wherein the light emitting device has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi):
Condition (A′): The average color rendering index Ra of light emitted from the light emitting device is 80 or more, and the color rendering index R9 thereof is 50 or more and 70 or less. In the condition (A′) in the light emitting device according to the third aspect, the average color rendering index Ra may be 90 or less, or may be 80 or more and 90 or less.
Condition (B): The average color rendering index Ra of light emitted from the light emitting device is 80 or more and 87 or less, and the special color rendering index R9 thereof is 50 or more. In the condition (B) in the light emitting device according to the third aspect, the special color rendering index R9 may be 98 or less, may be 95 or less, or may be 90 or less.
(i) When the correlated color temperature is 2,000 K or more and less than 2,800 K, the first light emission intensity ratio I₅₀₀ is 0.01 or more and 0.15 or less, 0.01 or more and 0.14 or less, or 0.01 or more and 0.12 or less;
(ii) when the correlated color temperature is 2,800 K or more and less than 3,300 K, the first light emission intensity ratio I₅₀₀ is 0.01 or more and 0.35 or less, 0.01 or more and 0.25 or less, or 0.01 or more and 0.18 or less;
(iii) when the correlated color temperature is 3,300 K or more and less than 3,700 K, the first light emission intensity ratio I₅₀₀ is 0.01 or more and 0.45 or less, 0.01 or more and 0.40 or less, or 0.01 or more and 0.20 or less;
(iv) when the correlated color temperature is 3,700 K or more and less than 4,500 K, the first light emission intensity ratio I₅₀₀ is 0.01 or more and 0.50 or less, 0.01 or more and 0.40 or less, or 0.01 or more and 0.30 or less;
(v) when the correlated color temperature is 4,500 K or more and less than 5,700 K, the first light emission intensity ratio I₅₀₀ is 0.01 or more and 0.55 or less, 0.01 or more and 0.50 or less, or 0.01 or more and 0.43 or less; and
(vi) when the correlated color temperature is 5,700 K or more and 6,800 K or less, the first light emission intensity ratio I₅₀₀ is 0.01 or more and 0.70 or less, 0.01 or more and 0.65 or less, or 0.01 or more and 0.60 or less.

According to the CIE (Commission Internationale de l'Eclarirage) guidelines for color rendering properties, a preferred average color rendering index Ra depending on the place of use is defined as 60 or more and less than 80 in factories for ordinary work; 80 or more and less than 90 in places such as residences, hotels, restaurants, shops, offices, schools, hospitals, and factories for precision work; and 90 or more in places for clinical inspection, museums, and other places where high color rendering properties are required.

The average color rendering index Ra of the light emission of the light emitting device is, for example, 80 or more. The upper limit of the average color rendering index Ra of the light emission of the light emitting device is 100. The average color rendering index Ra is preferably higher.

However, the luminous flux and the color rendering property are in a trade-off relationship, as described above. In order to increase the luminous flux while maintaining the color rendering property, the average color rendering index Ra may be 98 or less, may be 95 or less, or may be 90 or less. The special color rendering index is expressed by indices R9 to R15, where R9 is red, R10 is yellow, R11 is green, R12 is blue, R13 is a skin color of Western people, R14 is a color of leaves, and R15 is a skin color of Japanese people. The upper limit of each of the special color rendering indices R9 to R15 is 100. The special color rendering index is also preferably higher as long as the luminous flux is maintained. However, the luminous flux and the color rendering property are in a trade-off relationship, as described above. The special color rendering index R9 of the light emitting device is 50 or more from the viewpoint of emitting light having a high color rendering property, and may be 98 or less, may be 95 or less, may be 90 or less, may be 85 or less, or may be 80 or less from the viewpoint of increasing the luminous flux. The special color rendering index R15 of the light emitting device is 50 or more, preferably 60 or more, more preferably 70 or more, even more preferably 80 or more, and particularly preferably 85 or more, from the viewpoint of emitting light having a high color rendering property. The special color rendering index R15 of the light emitting device may be 98 or less, or may be 95 or less, from the viewpoint of increasing the luminous flux.

With the widespread use of LED lighting using LED-based light emitting devices, it has been considered that LED lighting may affect human circadian rhythms (biological rhythms). There is also a movement to emphasize consideration of the impact on the human body when designing a human work environment. One of them is, for example, a certification system called WELL certification (WELL Building Standard), established by IWBI (International WELL Building Institute). WELL certification evaluates buildings such as offices on several factors, including air, water, food, light, and comfort, and grants certification if they meet the criteria. For WELL certification, the color rendering property is not essential, but is an additional factor.

With the light emitting device and the illumination device that emit light having a high color rendering index, it is possible to earn additional points for WELL certification.

The light emitted from the light emitting device is a mixed color light of light emitted from the light emitting element and fluorescence emitted from the fluorescent material that absorbs the light irradiated from the light emitting element. The correlated color temperature of the light emitted from the light emitting device can be, for example, 2,000 K or more, and can be 6,800 K or less.

The light emitting element has a light emission peak wavelength of 430 nm or more and 470 nm or less. From the viewpoint of color rendering properties and obtaining a high luminous flux, the light emitting element may have a light emission peak wavelength of 440 nm or more and 465 nm or less, may have a light emission peak wavelength of 445 nm or more and 460 nm or less, or may have a light emission peak wavelength of 450 nm or more and 460 nm or less. The light emitting element may have a light emission spectrum with a full width at half maximum of, for example, 30 nm or less. The light emitting element used is preferably a semiconductor light emitting element such as an LED. By using a semiconductor light emitting element as the light source, it is possible to obtain a stable light emitting device having high efficiency, high output linearity with respect to the input, and high resistance to mechanical shock. Examples of the semiconductor light emitting element used include a semiconductor light emitting element emitting blue light or other colors using a nitride semiconductor (In_{X}Al_{Y}Ga_{1-X-Y}N, where X and Y satisfy 0≤X, 0≤Y, and X+Y≤1).

The first fluorescent material has a light emission peak wavelength of 510 nm or more and less than 590 nm. The first fluorescent material preferably contains at least one selected from the group consisting of a rare earth aluminate fluorescent material having a composition included in the compositional formula represented by the following formula (5) and a third nitride fluorescent material having a composition included in the compositional formula represented by the following formula (6):

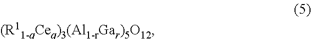

wherein R¹ represents at least one element selected from the group consisting of Y, Gd, Lu, and Tb, and q and r satisfy 0.001≤q≤0.20 and 0≤r<1.0;

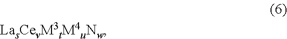

wherein M³ represents at least one selected from the group consisting of rare earth elements other than La and Ce, and may include at least one selected from the group consisting of Y, Gd, and Lu, M⁴ represents at least one selected from the group consisting of Si, Ge, B, Al, and Ga, and includes at least Si, and s, t, u, v, and w satisfy 2.7≤s+t+v≤3.3, 0≤t≤1.2, 5.0≤u≤6.6, 0≤v≤1.2, and 10≤w≤12.

The second fluorescent material has a light emission peak wavelength of 590 nm or more and 670 nm or less, and contains a first fluoride fluorescent material having a composition included in the compositional formula represented by the formula (1), or at least one fluoride fluorescent material selected from the group consisting of a first fluoride fluorescent material having a composition included in the compositional formula represented by the formula (1) and a second fluoride fluorescent material having a composition included in the compositional formula represented by the formula (2).

The light emitting device according to the first aspect preferably has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi). For the light emitting device according to the first aspect, when, in the range of the correlated color temperature described in any one of the following (i) to (vi), the first light emission intensity ratio I₅₀₀ in the light emission spectrum of the light emitting device is in the range described in the corresponding one of the following (i) to (vi), the color rendering index satisfies the range described in the condition (A) or (B), and the light emitting device emits light having a high luminous flux.
(i) When the correlated color temperature is 2,000 K or more and less than 2,800 K, the first light emission intensity ratio I₅₀₀ is 0.01 or more and 0.15 or less, 0.01 or more and 0.14 or less, or 0.01 or more and 0.12 or less;
(ii) when the correlated color temperature is 2,800 K or more and less than 3,300 K, the first light emission intensity ratio I₅₀₀ is 0.01 or more and 0.35 or less, 0.01 or more and 0.25 or less, or 0.01 or more and 0.18 or less;
(iii) when the correlated color temperature is 3,300 K or more and less than 3,700 K, the first light emission intensity ratio I₅₀₀ is 0.01 or more and 0.45 or less, 0.01 or more and 0.40 or less, or 0.01 or more and 0.20 or less;
(iv) when the correlated color temperature is 3,700 K or more and less than 4,500 K, the first light emission intensity ratio I₅₀₀ is 0.01 or more and 0.50 or less, 0.01 or more and 0.40 or less, or 0.01 or more and 0.30 or less;
(v) when the correlated color temperature is 4,500 K or more and less than 5,700 K, the first light emission intensity ratio I₅₀₀ is 0.01 or more and 0.55 or less, 0.01 or more and 0.50 or less, or 0.01 or more and 0.43 or less; and
(vi) when the correlated color temperature is 5,700 K or more and 6,800 K or less, the first light emission intensity ratio I₅₀₀ is 0.01 or more and 0.70 or less, 0.01 or more and 0.65 or less, or 0.01 or more and 0.60 or less.

For the light emitting device according to the first or third aspect, when a correlated color temperature of light emitted from the light emitting device is in a range described in any one of the following (i) to (vi), a light emission peak wavelength of the first fluorescent material that emits light when absorbing the light emitted from the light emitting element is preferably in a range described in the corresponding one of the following (i) to (vi). For the light emitting device according to the first or third aspect, when, in the range of the correlated color temperature described in any one of the following (i) to (vi), a first light emission peak wavelength is in the range described in the corresponding one of the following (i) to (vi), the color rendering index satisfies the range described in the condition (A), (A′), or (B), and the light emitting device emits light having a high luminous flux.
(i) When the correlated color temperature is 2,000 K or more and less than 2,800 K, the light emission peak wavelength of the first fluorescent material is 558 nm or more and 578 nm or less, 563 nm or more and 573 nm or less, 565 nm or more and 571 nm or less, or 566 nm or more and 570 nm or less;
(ii) when the correlated color temperature is 2,800 K or more and less than 3,300 K, the light emission peak wavelength of the first fluorescent material is 555 nm or more and 575 nm or less, 560 nm or more and 570 nm or less, 562 nm or more and 568 nm or less, or 563 nm or more and 567 nm or less;
(iii) when the correlated color temperature is 3,300 K or more and less than 3,700 K, the light emission peak wavelength of the first fluorescent material is 552 nm or more and 572 nm or less, 557 nm or more and 567 nm or less, 559 nm or more and 565 nm or less, or 560 nm or more and 564 nm or less;
(iv) when the correlated color temperature is 3,700 K or more and less than 4,500 K, the light emission peak wavelength of the first fluorescent material is 547 nm or more and 567 nm or less, 552 nm or more and 562 nm or less, 554 nm or more and 560 nm or less, or 555 nm or more and 559 nm or less;
(v) when the correlated color temperature is 4,500 K or more and less than 5,700 K, the light emission peak wavelength of the first fluorescent material is 538 nm or more and 558 nm or less, 543 nm or more and 553 nm or less, 545 nm or more and 551 nm or less, or 546 nm or more and 550 nm or less; and
(vi) when the correlated color temperature is 5,700 K or more and 6,800 K or less, the light emission peak wavelength of the first fluorescent material is 533 nm or more and 553 nm or less, 538 nm or more and 548 nm or less, 540 nm or more and 546 nm or less, or 541 nm or more and 545 nm or less.

The light emitting device according to the first or third aspect preferably has a light emission spectrum in which, when a correlated color temperature of light emitted from the light emitting device is in a range described in any one of the following (vii) to (x), a second light emission intensity ratio I₆₀₀ of a light emission intensity at a wavelength of 600 nm to a light emission intensity at a wavelength of 555 nm is in a range described in the corresponding one of the following (vii) to (x). For the light emitting device according to the first or third aspect, when, in the range of the correlated color temperature described in any one of the following (vii) to (x), the second light emission intensity ratio I₆₀₀ in the light emission spectrum of the light emitting device is in the range described in the corresponding one of the following (vii) to (x), the color rendering index satisfies the range described in the condition (A), (A′), or (B), and the light emitting device emits light having a high luminous flux.

In the spectral luminous efficiency curve V (λ) for photopic vision of humans specified by the CIE, the maximum sensitivity (peak sensitivity wavelength) is at 555 nm.
(vii) When the correlated color temperature is 2,000 K or more and less than 2,800 K, the second light emission intensity ratio I₆₀₀ is 0.10 or more and 0.92 or less, or 0.10 or more and 0.91 or less;
(viii) when the correlated color temperature is 2,800 K or more and less than 3,500 K, the second light emission intensity ratio I₆₀₀ is 0.10 or more and 0.87 or less, or 0.1 or more and 0.86 or less;
(ix) when the correlated color temperature is 3,500 K or more and less than 4,500 K, the second light emission intensity ratio I₆₀₀ is 0.10 or more and 0.98 or less, 0.10 or more and 0.90 or less, or 0.10 or more and 0.85 or less; and
(x) when the correlated color temperature is 4,500 K or more and 6,800 K or less, the second light emission intensity ratio I₆₀₀ is 0.10 or more and 0.90 or less, or 0.20 or more and 0.80 or less.

The light emitting device according to the second aspect preferably has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi). For the light emitting device according to the second aspect, when, in the range of the correlated color temperature described in any one of the following (i) to (vi), the first light emission intensity ratio I₅₀₀ in the light emission spectrum of the light emitting device is in the range described in the corresponding one of the following (i) to (vi), the color rendering index satisfies the range described in the condition (C), and the light emitting device emits light having a high luminous flux.
(i) When the correlated color temperature is 2,000 K or more and less than 2,800 K, the first light emission intensity ratio I₅₀₀ is 0.01 or more and 0.50 or less, 0.01 or more and 0.40 or less, or 0.01 or more and 0.30 or less;
(ii) when the correlated color temperature is 2,800 K or more and less than 3,300 K, the first light emission intensity ratio I₅₀₀ is 0.01 or more and 0.39 or less, 0.01 or more and 0.35 or less, or 0.01 or more and 0.30 or less;
(iii) when the correlated color temperature is 3,300 K or more and less than 3,700 K, the first light emission intensity ratio I₅₀₀ is 0.01 or more and 0.45 or less, 0.01 or more and 0.40 or less, or 0.01 or more and 0.30 or less;
(iv) when the correlated color temperature is 3,700 K or more and less than 4,500 K, the first light emission intensity ratio I₅₀₀ is 0.01 or more and 0.50 or less, 0.01 or more and 0.45 or less, or 0.01 or more and 0.40 or less;
(v) when the correlated color temperature is 4,500 K or more and less than 5,700 K, the first light emission intensity ratio I₅₀₀ is 0.01 or more and 0.55 or less, 0.01 or more and 0.53 or less, or 0.01 or more and 0.51 or less; and
(vi) when the correlated color temperature is 5,700 K or more and 6,800 K or less, the first light emission intensity ratio I₅₀₀ is 0.01 or more and 0.70 or less, 0.01 or more and 0.65 or less, or 0.01 or more and 0.60 or less.

For the light emitting device according to the second aspect, when a correlated color temperature of light emitted from the light emitting device is in a range described in any one of the following (i) to (vi), a light emission peak wavelength of the first fluorescent material that emits light when absorbing the light emitted from the light emitting element is preferably in a range described in the corresponding one of the following (i) to (vi). For the light emitting device according to the second aspect, when, in the range of the correlated color temperature described in any one of the following (i) to (vi), the first light emission peak wavelength is in the range described in the corresponding one of the following (i) to (vi), the color rendering index satisfies the range described in the condition (C), and the light emitting device emits light having a high luminous flux.
(i) When the correlated color temperature is 2,000 K or more and less than 2,800 K, the light emission peak wavelength of the first fluorescent material is 539 nm or more and 559 nm or less, 544 nm or more and 554 nm or less, 546 nm or more and 552 nm or less, or 547 nm or more and 551 nm or less;
(ii) when the correlated color temperature is 2,800 K or more and less than 3,300 K, the light emission peak wavelength of the first fluorescent material is 540 nm or more and 560 nm or less, 548 nm or more and 555 nm or less, 548 nm or more and 553 nm or less, or 549 nm or more and 552 nm or less;
(iii) when the correlated color temperature is 3,300 K or more and less than 3,700 K, the light emission peak wavelength of the first fluorescent material is 540 nm or more and 560 nm or less, 545 nm or more and 555 nm or less, 547 nm or more and 553 nm or less, or 548 nm or more and 552 nm or less;
(iv) when the correlated color temperature is 3,700 K or more and less than 4,500 K, the light emission peak wavelength of the first fluorescent material is 536 nm or more and 556 nm or less, 543 nm or more and 551 nm or less, 543 nm or more and 549 nm or less, or 544 nm or more and 548 nm or less;
(v) when the correlated color temperature is 4,500 K or more and less than 5,700 K, the light emission peak wavelength of the first fluorescent material is 533 nm or more and 553 nm or less, 541 nm or more and 548 nm or less, 541 nm or more and 546 nm or less, or 541 nm or more and 545 nm or less; and
(vi) when the correlated color temperature is 5,700 K or more and 6,800 K or less, the light emission peak wavelength of the first fluorescent material is 534 nm or more and 554 nm or less, 539 nm or more and 549 nm or less, 541 nm or more and 547 nm or less, or 542 nm or more and 546 nm or less.

The light emitting device according to the second aspect preferably has a light emission spectrum in which, when a correlated color temperature of light emitted from the light emitting device is in a range described in any one of the following (vii) to (x), a second light emission intensity ratio I₆₀₀ of a light emission intensity at a wavelength of 600 nm to a light emission intensity at a wavelength of 555 nm is in a range described in the corresponding one of the following (vii) to (x). For the light emitting device according to the second aspect, when, in the range of the correlated color temperature described in any one of the following (i) to (vi), the first light emission peak wavelength is in the range described in the corresponding one of the following (i) to (vi), the color rendering index satisfies the range described in the condition (C), and the light emitting device emits light having a high luminous flux.
(vii) When the correlated color temperature is 2,000 K or more and less than 2,800 K, the second light emission intensity ratio I₆₀₀ is 0.10 or more and 1.34 or less, 0.1 or more and 1.30 or less, or 0.1 or more and 1.27 or less;
(viii) when the correlated color temperature is 2,800 K or more and less than 3,300 K, the second light emission intensity ratio I₆₀₀ is 0.10 or more and 1.09 or less, 0.1 or more and 1.08 or less, or 0.10 or more and 1.07 or less;
(ix) when the correlated color temperature is 3,300 K or more and less than 4,500 K, the second light emission intensity ratio I₆₀₀ is 0.10 or more and 0.98 or less, 0.10 or more and 0.96 or less, or 0.10 or more and 0.94 or less; and
(x) when the correlated color temperature is 4,500 K or more and 6,800 K or less, the second light emission intensity ratio I₆₀₀ is 0.10 or more and 0.90 or less, 0.20 or more and 0.90 or less, or 0.20 or more and 0.85 or less.

In the fluorescent member used in the light emitting device according to the second aspect, a content of the second fluorescent material is preferably 86 parts by mass or more and 99.5 parts by mass or less, more preferably 90 parts by mass or more and 98 parts by mass or less, and even more preferably 92 parts by mass or more and 98 parts by mass or less, relative to a total amount of the second and third fluorescent materials being 100 parts by mass. The light emitting device using a fluorescent member in which the content of the second fluorescent material is in the range of 86 parts by mass or more and 99.5 parts by mass or less, relative to the total amount of the second and third fluorescent materials, has a color rendering index satisfying the range described in the condition (C), and emits light having a high luminous flux.

The fluorescent member used in the light emitting device preferably contains fluorescent materials including at least a first fluorescent material and a second fluorescent material, and a resin. Examples of the resin constituting the fluorescent member include a thermoplastic resin and a thermosetting resin. Specific examples of the thermosetting resin include an epoxy resin, a silicone resin, and a modified silicone resin such as an epoxy-modified silicone resin.

A blending amount of the fluorescent materials is preferably 10 parts by mass or more and 600 parts by mass or less, more preferably 20 parts by mass or more and 400 parts by mass or less, and even more preferably 30 parts by mass or more and 200 parts by mass or less, relative to 100 parts by mass of the resin.

The fluorescent member may contain other components, if necessary, in addition to the fluorescent materials and the resin. Examples of the other components include a filler such as silica, barium titanate, titanium oxide, and aluminum oxide, a light stabilizer, and a colorant. When the fluorescent member contains the other components, the content thereof is not particularly limited and may be appropriately selected according to the purpose or the like. For example, when the fluorescent member contains a filler as the other component, the content of the filler may be 0.01% by mass to 20% by mass relative to the amount of the resin.

The light emitting device can be produced by a method for producing a light emitting device including preparing a molded body, disposing a light emitting element, and forming a fluorescent member using a fluorescent member composition. When a collective molded body having a plurality of recessed portions is used as the molded body, the production method may include, after forming a fluorescent member using a fluorescent member composition, individualizing the fluorescent member by separating for each unit region. Each unit region refers to a region having at least one recessed portion. For the details, the disclosure of Japanese Unexamined Patent Publication No. 2010-062272 may be referred to, for example.

In preparing a molded body, a plurality of leads are integrally molded using a thermosetting resin or a thermoplastic resin to prepare a molded body having a recessed portion defined by side surfaces and a bottom surface. The molded body may be formed from a collective molded body including a plurality of recessed portions.

In disposing a light emitting element, a light emitting element is disposed on the bottom surface of the recessed portion of the molded body, and the positive and negative electrodes of the light emitting element are connected to a first lead and a second lead, respectively, by a wire.

In forming a fluorescent member using a fluorescent member composition, a fluorescent member composition containing fluorescent materials including a first fluorescent material, a second fluorescent material, and optionally a third fluorescent material, and a resin is placed on a support excluding a portion where the light emitting element is disposed. The support includes a first lead, a second lead, and a resin portion, and is constituted by a molded body having a recessed portion. The fluorescent member composition may be placed in the recessed portion by potting using a dispenser. The fluorescent member composition placed on the support is cured to form a fluorescent member.

When a molded body formed from a collective molded body having a plurality of recessed portions is used, in the individualizing step after forming a fluorescent member, the fluorescent member is separated in each unit region of the collective molded body having a plurality of recessed portions, thereby producing individual light emitting devices.

The illumination device may include at least one type of the above light emitting device. In addition, the illumination device may include at least one type of the above light emitting device in combination with a known light emitting device that emits mixed color light ranging from white to light bulb color or monochromatic light such as cyan. The illumination device may further include, in addition to the above light emitting device, members such as a reflecting member, a protective member, and an auxiliary device for supplying electric power to the light emitting device. The illumination device may include a plurality of the above light emitting devices. In the case where the illumination device includes a plurality of light emitting devices, it may include a plurality of the same light emitting devices, or it may include a plurality of light emitting devices having, for example, different correlated color temperatures. The illumination device may include a driving device capable of individually driving a plurality of light emitting devices and adjusting the brightness and correlated color temperature as desired. When the illumination device is used as a lighting fixture, it may be in the form of any of a direct attaching type, an embedding type, or a pendant type.

The present disclosure may include the following aspects.
[Aspect 1] A light emitting device comprising
   a light emitting element having a light emission peak wavelength of 430 nm or more and 470 nm or less, and
   a fluorescent member containing
      a first fluorescent material having a light emission peak wavelength of 510 nm or more and less than 590 nm and
      a second fluorescent material having a light emission peak wavelength of 590 nm or more and 670 nm or less and containing a first fluoride fluorescent material having a composition included in the compositional formula represented by the following formula (1)

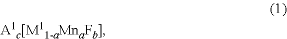

wherein A¹ includes at least K and optionally at least one element selected from the group consisting of Li, Na, Rb, and Cs, M¹ includes at least Si and Al and optionally at least one element selected from the group consisting of Group 4 elements, Group 13 elements, and Group 14 elements, a and b satisfy 0<a<0.2 and 5<b<7, and c represents the absolute value of the charge of [M¹₁₋ₐMnₐF_{b}] ions, and
wherein the light emitting device satisfies the following condition (A) or (B):
   the condition (A) is that an average color rendering index Ra of light emitted from the light emitting device is 80 or more and 90 or less, and a color rendering index R9 thereof is 50 or more and 90 or less; and
   the condition (B) is that an average color rendering index Ra of light emitted from the light emitting device is 80 or more and 87 or less, and a color rendering index R9 thereof is 50 or more.
[Aspect 2] A light emitting device comprising
   a light emitting element having a light emission peak wavelength of 430 nm or more and 470 nm or less, and
   a fluorescent member containing
      a first fluorescent material having a light emission peak wavelength of 510 nm or more and less than 590 nm,
      a second fluorescent material having a light emission peak wavelength of 590 nm or more and 670 nm or less and containing at least one fluoride fluorescent material selected from the group consisting of a first fluoride fluorescent material having a composition included in the compositional formula represented by the following formula (1) and a second fluoride fluorescent material having a composition included in the compositional formula represented by the following formula (2), and
      a third fluorescent material containing at least one nitride fluorescent material selected from the group consisting of a first nitride fluorescent material having a composition included in the compositional formula represented by the following formula (3) and a second nitride fluorescent material having a composition included in the compositional formula represented by the following formula (4):

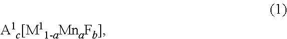

wherein A¹ includes at least K and optionally at least one element selected from the group consisting of Li, Na, Rb, and Cs, M¹ includes at least Si and Al and optionally at least one element selected from the group consisting of Group 4 elements, Group 13 elements, and Group 14 elements, a and b satisfy 0<a<0.2 and 5<b<7, and c represents the absolute value of the charge of [M¹₁₋ₐMnₐF_{b}] ions;

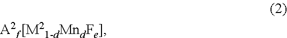

wherein A² includes at least one element selected from the group consisting of Li, Na, K, Rb, and Cs, M² includes at least one of Si and Ge and optionally at least one element selected from the group consisting of Group 4 elements and Group 14 elements, d and e satisfy 0<d<0.2 and 5<e<7, and f represents the absolute value of the charge of [M²_{1-d}Mn_{d}Fₑ] ions;

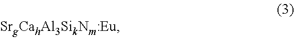

wherein g, h, j, k, and m satisfy 0≤g<1, 0<h≤1, g+h≤1, 0.9≤j≤1.1, 0.9≤k≤1.1, and 2.5≤m≤3.5; and

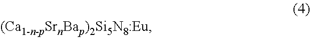

wherein n and p satisfy 0≤n≤1.0 and 0≤p≤1.0, and
wherein the light emitting device satisfies the following condition (C):
   the condition (C) is that an average color rendering index Ra of light emitted from the light emitting device is 80 or more and 90 or less, and a special color rendering index R9 thereof is 50 or more.
[Aspect 3] The light emitting device according to Aspect 1, wherein the light emitting device has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi):
   (i) when the correlated color temperature is 2,000 K or more and less than 2,800 K, the first light emission intensity ratio I₅₀₀ is 0.01 or more and 0.15 or less;
   (ii) when the correlated color temperature is 2,800 K or more and less than 3,300 K, the first light emission intensity ratio I₅₀₀ is 0.01 or more and 0.35 or less;
   (iii) when the correlated color temperature is 3,300 K or more and less than 3,700 K, the first light emission intensity ratio I₅₀₀ is 0.01 or more and 0.45 or less;
   (iv) when the correlated color temperature is 3,700 K or more and less than 4,500 K, the first light emission intensity ratio I₅₀₀ is 0.01 or more and 0.50 or less;
   (v) when the correlated color temperature is 4,500 K or more and less than 5,700 K, the first light emission intensity ratio I₅₀₀ is 0.01 or more and 0.55 or less; and
   (vi) when the correlated color temperature is 5,700 K or more and 6,800 K or less, the first light emission intensity ratio I₅₀₀ is 0.01 or more and 0.70 or less.
[Aspect 4] The light emitting device according to Aspect 2, wherein the light emitting device has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi):
   (i) when the correlated color temperature is 2,000 K or more and less than 2,800 K, the first light emission intensity ratio I₅₀₀ is 0.01 or more and 0.50 or less;
   (ii) when the correlated color temperature is 2,800 K or more and less than 3,300 K, the first light emission intensity ratio I₅₀₀ is 0.01 or more and 0.39 or less;
   (iii) when the correlated color temperature is 3,300 K or more and less than 3,700 K, the first light emission intensity ratio I₅₀₀ is 0.01 or more and 0.45 or less;
   (iv) when the correlated color temperature is 3,700 K or more and less than 4,500 K, the first light emission intensity ratio I₅₀₀ is 0.01 or more and 0.50 or less;
   (v) when the correlated color temperature is 4,500 K or more and less than 5,700 K, the first light emission intensity ratio I₅₀₀ is 0.01 or more and 0.55 or less; and
   (vi) when the correlated color temperature is 5,700 K or more and 6,800 K or less, the first light emission intensity ratio I₅₀₀ is 0.01 or more and 0.70 or less.
[Aspect 5] A light emitting device comprising
   a light emitting element having a light emission peak wavelength of 430 nm or more and 470 nm or less, and
   a fluorescent member containing
      a first fluorescent material having a light emission peak wavelength of 510 nm or more and less than 590 nm and
      a second fluorescent material having a light emission peak wavelength of 590 nm or more and 670 nm or less and containing a second fluoride fluorescent material having a composition included in the compositional formula represented by the following formula (2):

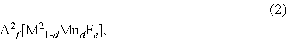

wherein A² includes at least one element selected from the group consisting of Li, Na, K, Rb, and Cs, M² includes at least one of Si and Ge and optionally at least one element selected from the group consisting of Group 4 elements and Group 14 elements, d and e satisfy 0<d<0.2 and 5<e<7, and f represents the absolute value of the charge of [M²_{1-d}Mn_{d}Fₑ] ions,
wherein the light emitting device satisfies the following condition (A′) or (B):
   the condition (A′) is that an average color rendering index Ra of light emitted from the light emitting device is 80 or more, and a color rendering index R9 thereof is 50 or more and 70 or less; and
   the condition (B) is that an average color rendering index Ra of light emitted from the light emitting device is 80 or more and 87 or less, and a special color rendering index R9 thereof is 50 or more, and
wherein the light emitting device has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi):
(i) when the correlated color temperature is 2,000 K or more and less than 2,800 K, the first light emission intensity ratio I₅₀₀ is 0.01 or more and 0.15 or less;
(ii) when the correlated color temperature is 2,800 K or more and less than 3,300 K, the first light emission intensity ratio I₅₀₀ is 0.01 or more and 0.35 or less;
(iii) when the correlated color temperature is 3,300 K or more and less than 3,700 K, the first light emission intensity ratio I₅₀₀ is 0.01 or more and 0.45 or less;
(iv) when the correlated color temperature is 3,700 K or more and less than 4,500 K, the first light emission intensity ratio I₅₀₀ is 0.01 or more and 0.50 or less;
(v) when the correlated color temperature is 4,500 K or more and less than 5,700 K, the first light emission intensity ratio I₅₀₀ is 0.01 or more and 0.55 or less; and
(vi) when the correlated color temperature is 5,700 K or more and 6,800 K or less, the first light emission intensity ratio I₅₀₀ is 0.01 or more and 0.70 or less.
[Aspect 6] The light emitting device according to Aspect 1, 3, or 5, wherein the light emitting device has a light emission spectrum in which, when a correlated color temperature of light emitted from the light emitting device is in a range described in any one of the following (vii) to (x), a second light emission intensity ratio I₆₀₀ of a light emission intensity at a wavelength of 600 nm to a light emission intensity at a wavelength of 555 nm is in a range described in the corresponding one of the following (vii) to (x):
   (vii) when the correlated color temperature is 2,000 K or more and less than 2,800 K, the second light emission intensity ratio I₆₀₀ is 0.10 or more and 0.92 or less;
   (viii) when the correlated color temperature is 2,800 K or more and less than 3,300 K, the second light emission intensity ratio I₆₀₀ is 0.10 or more and 0.87 or less;
   (ix) when the correlated color temperature is 3,300 K or more and less than 4,500 K, the second light emission intensity ratio I₆₀₀ is 0.10 or more and 0.98 or less; and
   (x) when the correlated color temperature is 4,500 K or more and 6,800 K or less, the second light emission intensity ratio I₆₀₀ is 0.10 or more and 0.90 or less.
[Aspect 7] The light emitting device according to Aspect 2 or 4, wherein the light emitting device has a light emission spectrum in which, when a correlated color temperature of light emitted from the light emitting device is in a range described in any one of the following (vii) to (x), a second light emission intensity ratio I₆₀₀ of a light emission intensity at a wavelength of 600 nm to a light emission intensity at a wavelength of 555 nm is in a range described in the corresponding one of the following (vii) to (x):
   (vii) when the correlated color temperature is 2,000 K or more and less than 2,800 K, the second light emission intensity ratio I₆₀₀ is 0.10 or more and 1.34 or less;
   (viii) when the correlated color temperature is 2,800 K or more and less than 3,300 K, the second light emission intensity ratio I₆₀₀ is 0.10 or more and 1.09 or less;
   (ix) when the correlated color temperature is 3,300 K or more and less than 4,500 K, the second light emission intensity ratio I₆₀₀ is 0.10 or more and 0.98 or less; and
   (x) when the correlated color temperature is 4,500 K or more and 6,800 K or less, the second light emission intensity ratio I₆₀₀ is 0.10 or more and 0.90 or less.
[Aspect 8] The light emitting device according to Aspect 1, 3, 5, or 6, wherein, when a correlated color temperature of light emitted from the light emitting device is in a range described in any one of the following (i) to (vi), the first fluorescent material that emits light when absorbing the light emitted from the light emitting element has a light emission peak wavelength in a range described in the corresponding one of the following (i) to (vi):
   (i) when the correlated color temperature is 2,000 K or more and less than 2,800 K, the light emission peak wavelength of the first fluorescent material is 558 nm or more and 578 nm or less;
   (ii) when the correlated color temperature is 2,800 K or more and less than 3,300 K, the light emission peak wavelength of the first fluorescent material is 555 nm or more and 575 nm or less;
   (iii) when the correlated color temperature is 3,300 K or more and less than 3,700 K, the light emission peak wavelength of the first fluorescent material is 552 nm or more and 572 nm or less;
   (iv) when the correlated color temperature is 3,700 K or more and less than 4,500 K, the light emission peak wavelength of the first fluorescent material is 547 nm or more and 567 nm or less;
   (v) when the correlated color temperature is 4,500 K or more and less than 5,700 K, the light emission peak wavelength of the first fluorescent material is 538 nm or more and 558 nm or less; and
   (vi) when the correlated color temperature is 5,700 K or more and 6,800 K or less, the light emission peak wavelength of the first fluorescent material is 533 nm or more and 553 nm or less.
[Aspect 9] The light emitting device according to Aspect 2, 4, or 7, wherein, when a correlated color temperature of light emitted from the light emitting device is in a range described in any one of the following (i) to (vi), the first fluorescent material that emits light when absorbing the light emitted from the light emitting element has a light emission peak wavelength in a range described in the corresponding one of the following (i) to (vi):
   (i) when the correlated color temperature is 2,000 K or more and less than 2,800 K, the light emission peak wavelength of the first fluorescent material is 539 nm or more and 559 nm or less;
   (ii) when the correlated color temperature is 2,800 K or more and less than 3,300 K, the light emission peak wavelength of the first fluorescent material is 540 nm or more and 560 nm or less;
   (iii) when the correlated color temperature is 3,300 K or more and less than 3,700 K, the light emission peak wavelength of the first fluorescent material is 540 nm or more and 560 nm or less;
   (iv) when the correlated color temperature is 3,700 K or more and less than 4,500 K, the light emission peak wavelength of the first fluorescent material is 536 nm or more and 556 nm or less;
   (v) when the correlated color temperature is 4,500 K or more and less than 5,700 K, the light emission peak wavelength of the first fluorescent material is 533 nm or more and 553 nm or less; and
   (vi) when the correlated color temperature is 5,700 K or more and 6,800 K or less, the light emission peak wavelength of the first fluorescent material is 534 nm or more and 554 nm or less.
[Aspect 10] The light emitting device according to Aspect 2, 4, 7, or 9, wherein a content of the second fluorescent material relative to a total amount of the second and third fluorescent materials being 100 parts by mass in the fluorescent member is 86 parts by mass or more and 99.5 parts by mass or less.
[Aspect 11] The light emitting device according to any one of Aspects 1 to 10, wherein the first fluorescent material contains at least one selected from the group consisting of a rare earth aluminate fluorescent material having a composition included in the compositional formula represented by the following formula (5) and a third nitride fluorescent material having a composition included in the compositional formula represented by the following formula (6):

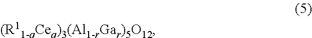

wherein R¹ represents at least one element selected from the group consisting of Y, Gd, Lu, and Tb, and q and r satisfy 0.001≤q≤0.20 and 0≤r<1.0; and

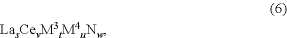

wherein M³ represents at least one selected from the group consisting of rare earth elements other than La and Ce, M⁴ represents at least one selected from the group consisting of Si, Ge, B, Al, and Ga, and includes at least Si, and s, t, u, v, and w satisfy 2.7≤s+t+v≤3.3, 0≤t≤1.2, 5.0≤u≤6.6, 0<v≤1.2, and 10≤w≤12.
[Aspect 12] The light emitting device according to any one of Aspects 1 to 11, wherein the light emitted from the light emitting device has a special color rendering index R15 of 80 or more.
[Aspect 13] An illumination device comprising the light emitting device according to any one of Aspects 1 to 12.

### EXAMPLES

The present invention is hereinafter specifically described with reference to the following Examples. The present invention is not limited to the following Examples.

For the light emitting devices according to Examples and Comparative Examples, the following first fluorescent materials and the second fluorescent materials were used.

First fluorescent materials, second fluorescent materials, and third fluorescent materials were prepared. Using a quantum efficiency measuring apparatus (QE-2000, manufactured by Otsuka Electronics Co., Ltd.), each fluorescent material was irradiated with light having an excitation wavelength of 450 nm to measure the light emission spectrum at room temperature (approximately 25° C.), and the light emission peak wavelength and the full width at half maximum were determined from each light emission spectrum. The results are shown in Tables 1 to 3.

As the first fluorescent materials, first fluorescent materials listed in Table 1 each having a different composition and a light emission peak wavelength of 510 nm or more and less than 590 nm, which are rare earth aluminate fluorescent materials each having a composition included in the compositional formula represented by the formula (5), were prepared. Each of these first fluorescent materials has a different light emission peak wavelength and a full width at half maximum, as shown in Table 1.

TABLE 1

| First fluorescent | | Light emission peak | Full width at half |
|---|---|---|---|
| material | | wavelength (nm) | maximum (nm) |
| Formula (5) | LAG1 | 525 | 100 |
| Formula (5) | LAG2 | 528 | 100 |
| Formula (5) | G-YAG1 | 535 | 107 |
| Formula (5) | G-YAG2 | 538 | 105 |
| Formula (5) | G-YAG3 | 540 | 110 |
| Formula (5) | G-YAG4 | 542 | 108 |
| Formula (5) | YAG1 | 550 | 110 |
| Formula (5) | YAG2 | 557 | 113 |
| Formula (5) | YAG3 | 565 | 115 |
| Formula (5) | YAG4 | 568 | 120 |

As the second fluorescent materials, second fluorescent materials listed in Table 2 each having a different composition and a light emission peak wavelength of 590 nm or more and 670 nm or less, which are a first fluoride fluorescent material having a composition included in the compositional formula represented by the formula (1) and a second fluoride fluorescent material having a composition included in the compositional formula represented by the formula (2), were prepared. The second fluoride fluorescent material having a composition included in the compositional formula represented by the formula (2) does not contain Al in the composition to the extent expressed in the molar ratio in the compositional formula represented by the formula (2).

TABLE 2

| Second fluorescent | | Light emission peak | Full width at half |
|---|---|---|---|
| material | | wavelength (nm) | maximum (nm) |
| Formula (1) | KSAF | 631 | 7 |
| Formula (2) | KSF | 631 | 7 |

As the third fluorescent materials, third fluorescent materials listed in Table 3 each having a different composition, which are first nitride fluorescent materials each having a composition included in the compositional formula represented by the formula (3), were prepared. Each of these third fluorescent materials has a different light emission peak wavelength and a full width at half maximum, as shown in Table 3.

TABLE 3

| Third fluorescent | | Light emission peak | Full width at half |
|---|---|---|---|
| material | | wavelength (nm) | maximum (nm) |
| Formula (3) | SCASN1 | 610 | 73 |
| Formula (3) | SCASN2 | 620 | 74 |
| Formula (3) | SCASN3 | 627 | 75 |
| Formula (3) | SCASN4 | 630 | 75 |

As the light emitting element, a gallium nitride-based semiconductor light emitting element having a light emission peak wavelength of 450 nm was prepared.

For the light emitting devices according to Examples and Comparative Examples, the chromaticity coordinates, the correlated color temperature (K), the average color rendering index (Ra (R1 to R8)), and the special color rendering indices (R9 to R15) of the emitted light were measured. The results of the average color rendering index and the special color rendering indices R9 and R15 are shown in each Table. Specifically, for each light emitting device, the chromaticity coordinates (x, y) in the chromaticity coordinate system of the CIE 1931 chromaticity diagram and the luminous flux were determined using an optical measuring system combining a spectrophotometer (PMA-12, manufactured by Hamamatsu Photonics K.K.) and an integral sphere. In the light emitting devices each having a correlated color temperature, the luminous flux of each of Examples and Comparative Examples was determined as a relative luminous flux, assuming that the luminous flux of the light emitting device according to one Comparative Example was 100%. The results are shown in each Table.

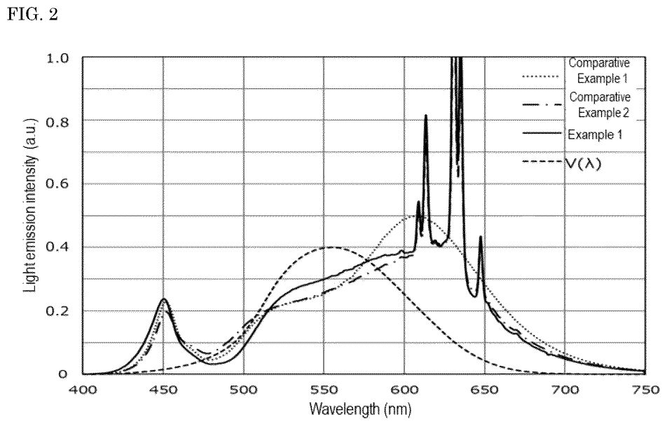

The light emission spectrum of the light emitting device according to each of Examples and Comparative Examples was measured using a spectrofluorometer. FIGS. 2 to 16 show the light emission spectrum of each light emitting device and a spectral luminous efficiency curve V (λ) for photopic vision of humans specified by the CIE.

### Examples 1 and 2

A light emitting element having a light emission peak wavelength of 450 nm and a fluorescent member composition containing a first fluorescent material, a second fluorescent material, and optionally a third fluorescent material listed in Table 4 so as to have a correlated color temperature of around 2,700 K, and containing a silicone resin, were prepared. The total amount of the first fluorescent material, the second fluorescent material, and optionally the third fluorescent material relative to 100 parts by mass of the silicone resin is shown in Table 4 as the blending amount (parts by mass) of the fluorescent materials relative to 100 parts by mass of the resin. The content ratio (% by mass) of each fluorescent material relative to the total amount of the fluorescent materials being 100% by mass, and the amount (parts by mass) of the second fluorescent material relative to the total amount of the second fluorescent material and the third fluorescent material being 100 parts by mass, are also shown in Table 4. In the following Tables, the symbol “-” indicates that there is no corresponding item or numerical value.

A light emitting device shown in FIG. 1 was produced. Specifically, a molded body having a recessed portion was prepared, the light emitting element described above was placed on the bottom surface of the recessed portion of the molded body, and the positive and negative electrodes of the light emitting element were connected to the first lead and the second lead, respectively, by a wire.

The fluorescent member composition was placed on the portion excluding the portion where the light emitting element was placed on the support constituted by the molded body including the first lead, the second lead, and the resin portion and having the recessed portion, and the fluorescent member composition was cured to form a fluorescent member.

A light emitting device including the light emitting element and the fluorescent member was produced after undergoing an individualizing step if necessary.

### Comparative Example 1

A light emitting device was produced in the same or similar manner as in Example 1, except that a fluorescent member composition containing no second fluorescent material, and containing a first fluorescent material and a third fluorescent material listed in Table 4, was used.

### Comparative Example 2

A light emitting device was produced in the same or similar manner as in Example 1, except that a fluorescent member composition containing a first fluorescent material, a second fluorescent material, and a third fluorescent material listed in Table 4, was used.

### Example 14

A light emitting device was produced in the same or similar manner as in Example 1, except that a fluorescent member composition containing a first fluorescent material and a second fluorescent material listed in Table 4, was used.

TABLE 4

| | | | | | Comparative | Comparative |
|---|---|---|---|---|---|---|
| | | Example 1 | Example 2 | Example 14 | Example 1 | Example 2 |
| Fluorescent | First | G-YAG2/ | YAG4 | YAG4 | G-YAG3 | G-YAG2/ |
| materials | fluorescent | YAG1 | | | | LAG1 |
| | material | (10/90) | | | | (80/20) |
| | Second | KSAF | KSAF | KSF | — | KSAF |
| | fluorescent | | | | | |
| | material | | | | | |
| | Third | SCASN4 | — | — | SCASN2 | SCASN4 |
| | fluorescent | | | | | |
| Blending amount of | | 97.0 | 90.0 | 90.0 | 44.0 | 100.00 |
| fluorescent materials | | | | | | |
| relative to 100 parts | | | | | | |
| by mass of resin | | | | | | |
| (parts by mass) | | | | | | |
| Content ratio in | First | 51.5 | 32.3 | 32.8 | 93.3 | 55.7 |
| total fluorescent | fluorescent | | | | | |
| material amount | material | | | | | |
| (% by mass) | Second | 47.1 | 67.8 | 67.2 | — | 42.1 |
| | fluorescent | | | | | |
| | material | | | | | |
| | Third | 1.5 | — | — | 6.7 | 2.2 |
| | fluorescent | | | | | |
| | material | | | | | |
| Second fluorescent material/ | | 97.0 | 100.0 | 100.0 | 0.0 | 95.0 |
| (second fluorescent material + | | | | | | |
| third fluorescent material) | | | | | | |
| (parts by mass) | | | | | | |
| Correlated color | | 2707 | 2709 | 2703 | 2704 | 2706 |
| temperature (K) | | | | | | |
| Chromaticity | x | 0.458 | 0.458 | 0.458 | 0.458 | 0.458 |
| coordinates | y | 0.410 | 0.410 | 0.410 | 0.410 | 0.410 |
| Relative luminous flux (%) | | 104.2 | 101.4 | 101.6 | 100.0 | 96.0 |
| Color rendering | Ra | 89 | 85 | 86 | 84 | 96 |
| index | R9 | 57 | 69 | 71 | 8 | 68 |
| | R15 | 88 | 92 | 92 | 74 | 93 |

| | | | | | |
|---|---|---|---|---|---|
| First intensity ratio I₅₀₀ | 0.28 | 0.09 | 0.10 | 0.46 | 0.56 |
| Second intensity ratio I₆₀₀ | 1.23 | 0.89 | 0.90 | 1.84 | 1.38 |

The light emitting device according to each of Examples 1, 2, and 14 emitted a mixed color light having a correlated color temperature of around 2,700 K, an average color rendering index Ra of 80 or more, a special color rendering index R9 of 50 or more, and a special color rendering index R15 of 80 or more. The light emitting device according to Example 1 had a first light emission intensity ratio I₅₀₀ of 0.01 or more and 0.50 or less, and a second light emission intensity ratio I₆₀₀ of 0.10 or more and 1.34 or less. The light emitting device according to each of Examples 2 and 14 had a first light emission intensity ratio I₅₀₀ of 0.01 or more and 0.15 or less, and a second light emission intensity ratio I₆₀₀ of 0.10 or more and 0.92 or less. The light emitting device according to each of Examples 1, 2, and 14 had a luminous flux higher than that of the light emitting device according to each of Comparative Examples 1 and 2. The light emitting devices according to Examples 2 and 14 both contained the same first fluorescent material; and as the second fluorescent material, the light emitting device according to Example 2 contained a KSAF having a composition included in the compositional formula represented by the formula (1), and the light emitting device according to Example 14 contained a KSF having a composition included in the compositional formula represented by the formula (2). The difference between the light emitting device according to Example 2 and the light emitting device according to Example 14 was small in terms of the values of the relative luminous flux, the average color rendering index Ra, the special color change index R9, the first light emission intensity ratio I₅₀₀, and the second light emission intensity ratio I₆₀₀, and the both light emitting devices emitted light having a high color rendering index and a high luminous flux. The results show that the light emitting device containing a KSAF having a composition included in the compositional formula represented by the formula (1) as the second fluorescent material and the light emitting device containing a KSF having a composition included in the compositional formula represented by the formula (2) as the second fluorescent material, when they contain the same first fluorescent material and the respective second fluorescent material so as to have a comparable target correlated color temperature, and when other conditions are the same, can emit light having a high color rendering index and a high luminous flux. For a light emitting device containing a KSAF having a composition included in the compositional formula represented by the formula (1) as the second fluorescent material and containing first and third fluorescent materials, and for a light emitting device containing a KSF having a composition included in the compositional formula represented by the formula (2) as the second fluorescent material and containing the same first and third fluorescent materials, when they contain the first fluorescent material, the respective second fluorescent material, and the third fluorescent material so as to have a comparable target correlated color temperature, and when other conditions are the same, the light emitting devices are presumed to have approximately the same relative luminous flux, average color rendering index Ra, special color change index R9, first light emission intensity ratio I₅₀₀, and second light emission intensity ratio I₆₀₀, and to emit light having a high color rendering index and a high luminous flux.

The light emitting device according to Comparative Example 1 did not contain a second fluorescent material in the fluorescent member, and had a special color rendering index R9 representing the color red of less than 50. The light emitting device according to Comparative Example 2 had a first light emission intensity ratio I₅₀₀ of more than 0.50. The light emitting device according to each of Comparative Examples 1 and 2 had a second light emission intensity ratio I₆₀₀ of more than 1.34. The light emitting device according to Comparative Example 2 had a high color rendering index, with an average color rendering index Ra of more than 90, but a low relative luminous flux.

FIG. 2 is a graph showing light emission spectra of the light emitting devices according to Example 1 and Comparative Examples 1 and 2, and a spectral luminous efficiency curve V (λ) for photopic vision of humans. The light emitting device according to Example 1 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 1 and 2, at 555 nm, which is the peak sensitivity wavelength of the spectral luminous efficiency curve for photopic vision of humans.

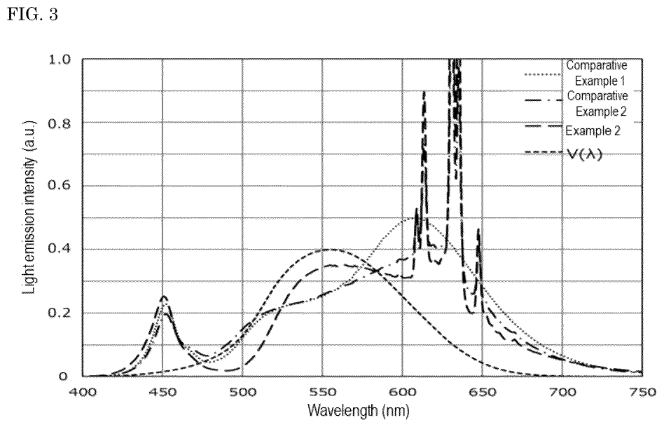

FIG. 3 is a graph showing light emission spectra of the light emitting devices according to Example 2 and Comparative Examples 1 and 2, and a spectral luminous efficiency curve V (λ) for photopic vision of humans. The light emitting device according to Example 2 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 1 and 2, at 555 nm, which is the peak sensitivity wavelength of the spectral luminous efficiency curve for photopic vision of humans.

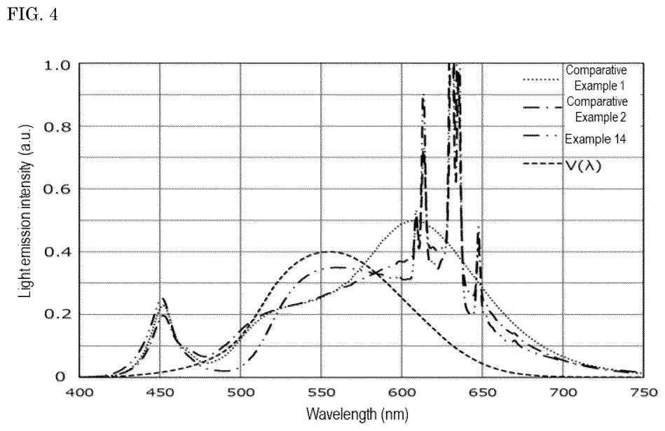

FIG. 4 is a graph showing light emission spectra of the light emitting devices according to Example 14 and Comparative Examples 1 and 2, and a spectral luminous efficiency curve V (λ) for photopic vision of humans. The light emitting device according to Example 14 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 1 and 2, at 555 nm, which is the peak sensitivity wavelength of the spectral luminous efficiency curve for photopic vision of humans.

### Examples 3 to 5

A light emitting element having a light emission peak wavelength of 450 nm and a fluorescent member composition containing a first fluorescent material, a second fluorescent material, and optionally a third fluorescent material listed in Table 5 so as to have a correlated color temperature of around 3,000 K, and containing a silicone resin, were prepared. The total amount of the first fluorescent material, the second fluorescent material, and optionally the third fluorescent material relative to 100 parts by mass of the silicone resin is shown in Table 5 as the blending amount (parts by mass) of the fluorescent materials relative to 100 parts by mass of the resin. The content ratio (% by mass) of each fluorescent material relative to the total amount of the fluorescent materials being 100% by mass, and the amount (parts by mass) of the second fluorescent material relative to the total amount of the second fluorescent material and the third fluorescent material being 100 parts by mass, are also shown in Table 5.

A light emitting device shown in FIG. 1 was produced. Specifically, a light emitting device was produced in the same or similar manner as in Example 1, except that a fluorescent member composition shown in Table 5 was used.

### Comparative Example 3

A light emitting device was produced in the same or similar manner as in Example 3, except that a fluorescent member composition containing no second fluorescent material, and containing a first fluorescent material and a third fluorescent material listed in Table 5, was used.

### Comparative Example 4

A light emitting device was produced in the same or similar manner as in Example 3, except that a fluorescent member composition containing a first fluorescent material, a second fluorescent material, and a third fluorescent material listed in Table 5, was used.

TABLE 5

| | | | | | Comparative | Comparative |
|---|---|---|---|---|---|---|
| | | Example 3 | Example 4 | Example 5 | Example 3 | Example 4 |
| Fluorescent | First | YAG1 | YAG3 | YAG2/ | G-YAG1/ | G-YAG2/ |
| materials | fluorescent | | | YAG3 | G-YAG3 | YAG1 |
| | material | | | (50/50) | (40/60) | (60/40) |
| | Second | KSAF | KSAF | KSAF | — | KSAF |
| | fluorescent | | | | | |
| | material | | | | | |
| | Third | SCASN2 | — | — | SCASN3 | SCASN2 |
| | fluorescent | | | | | |
| | material | | | | | |
| Blending amount of | | 155.5 | 142.7 | 137.5 | 103.0 | 146.6 |
| fluorescent materials | | | | | | |
| relative to 100 parts | | | | | | |
| by mass of resin | | | | | | |
| (parts by mass) | | | | | | |
| Content ratio in | First | 49.7 | 35.3 | 34.1 | 95.1 | 48.3 |
| total fluorescent | fluorescent | | | | | |
| material amount | material | | | | | |
| (% by mass) | Second | 48.8 | 64.7 | 65.9 | — | 49.1 |
| | fluorescent | | | | | |
| | material | | | | | |
| | Third | 1.5 | — | — | 5.9 | 2.6 |
| | fluorescent | | | | | |
| | material | | | | | |
| Second fluorescent material/ | | 97.0 | 100.0 | 100.0 | 0.0 | 95.0 |
| (second fluorescent material + | | | | | | |
| third fluorescent material) | | | | | | |
| (parts by mass) | | | | | | |
| Correlated color | | 3020 | 3025 | 3025 | 3022 | 3024 |
| temperature (K) | | | | | | |
| Chromaticity | x | 0.434 | 0.434 | 0.434 | 0.434 | 0.434 |
| coordinates | y | 0.403 | 0.403 | 0.403 | 0.403 | 0.403 |
| Relative luminous flux (%) | | 104.2 | 103.3 | 101.9 | 100.0 | 101.2 |
| Color rendering | Ra | 88 | 85 | 88 | 84 | 91 |
| index | R9 | 61 | 76 | 89 | 10 | 62 |
| | R15 | 89 | 93 | 98 | 75 | 90 |

| | | | | | |
|---|---|---|---|---|---|
| First intensity ratio I₅₀₀ | 0.26 | 0.14 | 0.18 | 0.48 | 0.42 |
| Second intensity ratio I₆₀₀ | 1.05 | 0.85 | 0.83 | 1.61 | 1.13 |

The light emitting device according to each of Examples 3 to 5 emitted a mixed color light having a correlated color temperature of around 3,000 K, an average color rendering index Ra of 80 or more, a special color rendering index R9 of 50 or more, and a special color rendering index R15 of 80 or more. The light emitting device according to Example 3 had a first light emission intensity ratio I₅₀₀ of 0.01 or more and 0.39 or less, and a second light emission intensity ratio I₆₀₀ of 0.10 or more and 1.09 or less. The light emitting device according to each of Examples 4 and 5Shad a first light emission intensity ratio I₆₀₀ of 0.01 or more and 0.35 or less, and a second light emission intensity ratio I₆₀₀ of 0.10 or more and 0.87 or less. The light emitting device according to each of Examples 3 to 5 had a luminous flux higher than that of the light emitting device according to each of Comparative Examples 3 and 4. A light emitting device containing the same first fluorescent material as that of the light emitting device according to each of Examples 4 and 5, and containing a KSF having a composition included in the compositional formula represented by the formula (2) as the second fluorescent material, instead of the KSAF having a composition included in the compositional formula represented by the formula (1), is presumed to have a target correlation color temperature of 3,000 K as in Examples 4 and 5, and approximately the same relative luminous flux, average color rendering index Ra, special color change index R9, first light emission intensity ratio I₅₀₀, and second light emission intensity ratio I₅₀₀ as those of the light emitting device according to each of Examples 4 and 5 even when the correlated color temperature is around 3,000 K, and is presumed to emit light having a high color rendering index and a high luminous flux. A light emitting device containing the same first and third fluorescent materials as those of the light emitting device according to Example 3, and containing a KSF having a composition included in the compositional formula represented by the formula (2) as the second fluorescent material, instead of the KSAF having a composition included in the compositional formula represented by the formula (1), is presumed to have a target correlation color temperature of 3,000 K as in Example 3, and approximately the same relative luminous flux, average color rendering index Ra, special color change index R9, first light emission intensity ratio I₅₀₀, and second light emission intensity ratio I₆₀₀ as those of the light emitting device according to Example 3 even when the correlated color temperature is around 3,000 K, and is presumed to emit light having a high color rendering index and a high luminous flux.

The light emitting device according to Comparative Example 3 did not contain a second fluorescent material in the fluorescent member, and had a special color rendering index R9 representing the color red of less than 50. The light emitting device according to each of Comparative Examples 3 and 4 had a first light emission intensity ratio I₅₀₀ of more than 0.39, and a second light emission intensity ratio I₆₀₀ of more than 1.09. The light emitting device according to Comparative Example 4 had an average color rendering index Ra of more than 90.

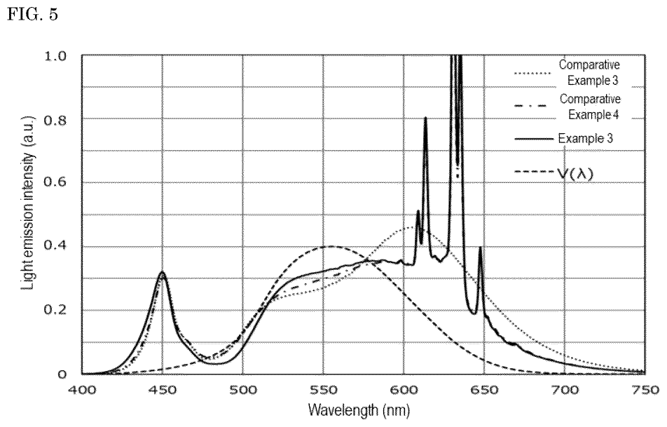

FIG. 5 is a graph showing light emission spectra of the light emitting devices according to Example 3 and Comparative Examples 3 and 4, and a spectral luminous efficiency curve V (λ) for photopic vision of humans. The light emitting device according to Example 3 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 3 and 4, at 555 nm, which is the peak sensitivity wavelength of the spectral luminous efficiency curve for photopic vision of humans.

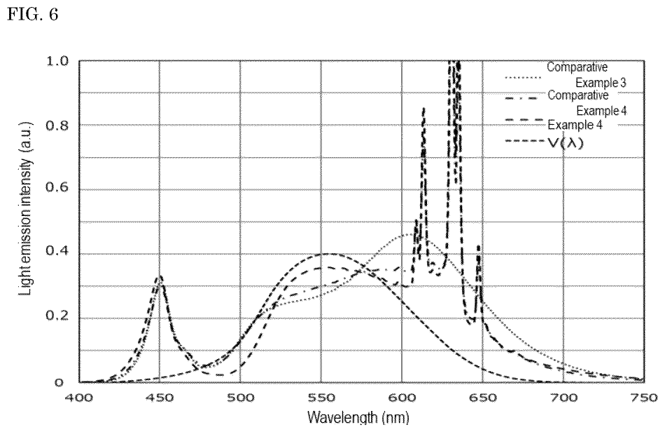

FIG. 6 is a graph showing light emission spectra of the light emitting devices according to Example 4 and Comparative Examples 3 and 4, and a spectral luminous efficiency curve V (λ) for photopic vision of humans. The light emitting device according to Example 4 resulted in emitting light that was easily visible to humans because the light emission spectrum thereof had a light emission intensity closer to that of the spectral luminous efficiency curve V (λ) for photopic vision of humans, compared to that of the light emission spectrum of the light emitting device according to each of Comparative Examples 3 and 4, at 555 nm, which is the peak sensitivity wavelength of the spectral luminous efficiency curve for photopic vision of humans.

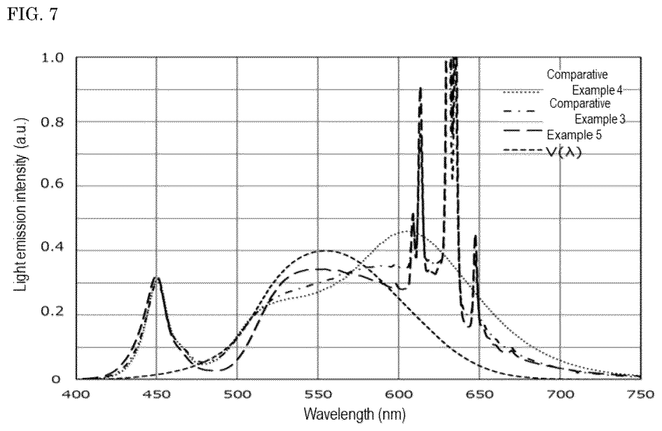

FIG. 7 is a graph showing light emission spectra of the light emitting devices according to Example 5 and Comparative Examples 3 and 4, and a spectral luminous efficiency curve V (λ) for photopic vision of humans. The light emitting device according to Example 5 resulted in emitting light that was easily visible to humans because the light emission spectrum thereof had a light emission intensity closer to that of the spectral luminous efficiency curve V (λ) for photopic vision of humans, compared to that of the light emission spectrum of the light emitting device according to each of Comparative Examples 3 and 4, at 555 nm, which is the peak sensitivity wavelength of the spectral luminous efficiency curve for photopic vision of humans.

### Examples 6 and 7

A light emitting element having a light emission peak wavelength of 450 nm and a fluorescent member composition containing a first fluorescent material, a second fluorescent material, and optionally a third fluorescent material listed in Table 6 so as to have a correlated color temperature of around 3,500 K, and containing a silicone resin, were prepared. The total amount of the first fluorescent material, the second fluorescent material, and optionally the third fluorescent material relative to 100 parts by mass of the silicone resin is shown in Table 6 as the blending amount (parts by mass) of the fluorescent materials relative to 100 parts by mass of the resin. The content ratio (% by mass) of each fluorescent material relative to the total amount of the fluorescent materials being 100% by mass, and the amount (parts by mass) of the second fluorescent material relative to the total amount of the second fluorescent material and the third fluorescent material being 100 parts by mass, are also shown in Table 6.

A light emitting device shown in FIG. 1 was produced. Specifically, a light emitting device was produced in the same or similar manner as in Example 1, except that a fluorescent member composition shown in Table 6 was used.

### Comparative Example 5

A light emitting device was produced in the same or similar manner as in Example 6, except that a fluorescent member composition containing no second fluorescent material, and containing a first fluorescent material and a third fluorescent material listed in Table 6, was used.

### Comparative Example 6

A light emitting device was produced in the same or similar manner as in Example 6, except that a fluorescent member composition containing a first fluorescent material, a second fluorescent material, and a third fluorescent material listed in Table 6, was used.

TABLE 6

| | | | | Comparative | Comparative |
|---|---|---|---|---|---|
| | | Example 6 | Example 7 | Example 5 | Example 6 |
| Fluorescent | First fluorescent | YAG1 | YAG2/YAG3 | G-YAG3 | G-YAG2/YAG1 |
| materials | material | | (35/65) | | (80/20) |
| | Second fluorescent | KSAF | KSAF | — | KSAF |
| | material | | | | |
| | Third fluorescent | SCASN1 | — | SCASN3 | SCASN1 |
| | material | | | | |
| Blending amount of fluorescent | | 136.8 | 104.9 | 62.8 | 133.6 |
| materials relative to 100 parts | | | | | |
| by mass of resin (parts by mass) | | | | | |
| Content ratio in | First fluorescent | 52.4 | 45.8 | 95.0 | 48.8 |
| total fluorescent | material | | | | |
| material amount | Second fluorescent | 45.9 | 54.2 | — | 47.6 |
| (% by mass) | material | | | | |
| | Third fluorescent | 1.7 | — | 5.0 | 3.6 |
| | material | | | | |
| Second fluorescent material/ | | 96.5 | 100.0 | 0.0 | 93.0 |
| (second fluorescent material + | | | | | |
| third fluorescent material) | | | | | |
| (parts by mass) | | | | | |
| Correlated color temperature (K) | | 3449 | 3443 | 3439 | 3441 |
| Chromaticity | x | 0.407 | 0.407 | 0.407 | 0.407 |
| coordinates | y | 0.392 | 0.392 | 0.392 | 0.392 |
| Relative luminous flux (%) | | 105.1 | 103.6 | 100.0 | 99.0 |
| Color rendering | Ra | 86 | 83 | 85 | 92 |
| index | R9 | 63 | 66 | 17 | 68 |
| | R15 | 89 | 89 | 77 | 91 |

| | | | | |
|---|---|---|---|---|
| First intensity ratio I₅₀₀ | 0.28 | 0.16 | 0.52 | 0.51 |
| Second intensity ratio I₆₀₀ | 0.92 | 0.81 | 1.43 | 1.00 |

The light emitting device according to each of Examples 6 and 7 emitted a mixed color light having a correlated color temperature of around 3,500 K, an average color rendering index Ra of 80 or more, a special color rendering index R9 of 50 or more, and a special color rendering index R15 of 80 or more. The light emitting device according to each of Examples 6 and 7 had a first light emission intensity ratio I₅₀₀ of 0.01 or more and 0.45 or less, and a second light emission intensity ratio I₆₀₀ of 0.10 or more and 0.98 or less. The light emitting device according to each of Examples 6 and 7 had a luminous flux higher than that of the light emitting device according to each of Comparative Examples 5 and 6. A light emitting device containing the same first fluorescent material as that of the light emitting device according to Example 7, and containing a KSF having a composition included in the compositional formula represented by the formula (2) as the second fluorescent material, instead of the KSAF having a composition included in the compositional formula represented by the formula (1), is presumed to have a target correlation color temperature of 3,500 K as in Example 7, and approximately the same relative luminous flux, average color rendering index Ra, special color change index R9, first light emission intensity ratio I₅₀₀, and second light emission intensity ratio I₆₀₀ as those of the light emitting device according to Example 7 even when the correlated color temperature is around 3,500 K, and is presumed to emit light having a high color rendering index and a high luminous flux. A light emitting device containing the same first and third fluorescent materials as those of the light emitting device according to Example 6, and containing a KSF having a composition included in the compositional formula represented by the formula (2) as the second fluorescent material, instead of the KSAF having a composition included in the compositional formula represented by the formula (1), is presumed to have a target correlation color temperature of 3,500 K as in Example 6, and approximately the same relative luminous flux, average color rendering index Ra, special color change index R9, first light emission intensity ratio I₅₀₀, and second light emission intensity ratio I₆₀₀ as those of the light emitting device according to Example 6 even when the correlated color temperature is around 3,500 K, and is presumed to emit light having a high color rendering index and a high luminous flux.

The light emitting device according to Comparative Example 5 did not contain a second fluorescent material in the fluorescent member, and had a special color rendering index R9 representing the color red of less than 50 and a special color rendering index R15 of less than 80. The light emitting device according to each of Comparative Examples 5 and 6 had a first light emission intensity ratio I₅₀₀ of more than 0.45, and a second light emission intensity ratio I₆₀₀ of more than 0.98. The light emitting device according to Comparative Example 6 had a high color rendering index, with an average color rendering index Ra of more than 90, but a low relative luminous flux.

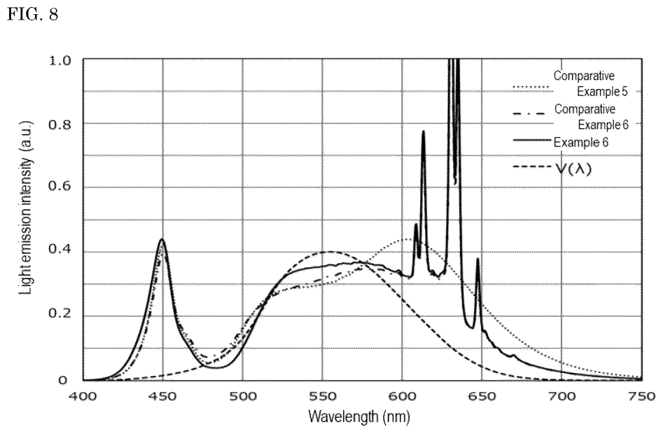

FIG. 8 is a graph showing light emission spectra of the light emitting devices according to Example 6 and Comparative Examples 5 and 6, and a spectral luminous efficiency curve V (λ) for photopic vision of humans. The light emitting device according to Example 6 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 5 and 6, at 555 nm, which is the peak sensitivity wavelength of the spectral luminous efficiency curve for photopic vision of humans.

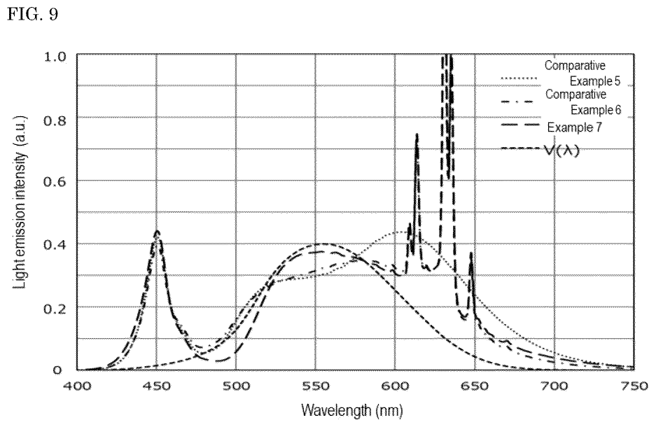

FIG. 9 is a graph showing light emission spectra of the light emitting devices according to Example 7 and Comparative Examples 5 and 6, and a spectral luminous efficiency curve V (λ) for photopic vision of humans. The light emitting device according to Example 6 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 5 and 6, at 555 nm, which is the peak sensitivity wavelength of the spectral luminous efficiency curve for photopic vision of humans.

### Examples 8 and 9

A light emitting element having a light emission peak wavelength of 450 nm and a fluorescent member composition containing a first fluorescent material, a second fluorescent material, and optionally a third fluorescent material listed in Table 7 so as to have a correlated color temperature of around 4,000 K, and containing a silicone resin, were prepared. The total amount of the first fluorescent material, the second fluorescent material, and optionally the third fluorescent material relative to 100 parts by mass of the silicone resin is shown in Table 7 as the blending amount (parts by mass) of the fluorescent materials relative to 100 parts by mass of the resin. The content ratio (% by mass) of each fluorescent material relative to the total amount of the fluorescent materials being 100% by mass, and the amount (parts by mass) of the second fluorescent material relative to the total amount of the second fluorescent material and the third fluorescent material being 100 parts by mass, are also shown in Table 7.

A light emitting device shown in FIG. 1 was produced. Specifically, a light emitting device was produced in the same or similar manner as in Example 1, except that a fluorescent member composition shown in Table 7 was used.

### Comparative Example 7

A light emitting device was produced in the same or similar manner as in Example 8, except that a fluorescent member composition containing no second fluorescent material, and containing a first fluorescent material and a third fluorescent material listed in Table 7, was used.

### Comparative Example 8

A light emitting device was produced in the same or similar manner as in Example 8, except that a fluorescent member composition containing a first fluorescent material, a second fluorescent material, and a third fluorescent material listed in Table 7, was used.

TABLE 7

| | | | | Comparative | Comparative |
|---|---|---|---|---|---|
| | | Example 8 | Example 9 | Example 7 | Example 8 |
| Fluorescent | First fluorescent | G-YAG2/YAG1 | YAG2 | G-YAG1/G-YAG3 | G-YAG2/YAG1 |
| materials | material | (30/70) | | (15/85) | (70/30) |
| | Second fluorescent | KSAF | KSAF | — | KSAF |
| | material | | | | |
| | Third fluorescent | SCASN1 | — | SCASN3 | SCASN1 |
| | material | | | | |
| Blending amount of fluorescent | | 113.6 | 97.4 | 61.1 | 113.4 |
| materials relative to 100 parts | | | | | |
| by mass of resin (parts by mass) | | | | | |
| Content ratio in | First fluorescent | 57.0 | 53.5 | 95.5 | 49.4 |
| total fluorescent | material | | | | |
| material amount | Second fluorescent | 41.7 | 46.5 | — | 49.1 |
| (% by mass) | material | | | | |
| | Third fluorescent | 1.3 | — | 4.5 | 1.5 |
| | material | | | | |
| Second fluorescent material/ | | 97.0 | 100.0 | 0.0 | 97.0 |
| (second fluorescent material + | | | | | |
| third fluorescent material) | | | | | |
| (parts by mass) | | | | | |
| Correlated color temperature (K) | | 3938 | 3934 | 3932 | 3934 |
| Chromaticity | x | 0.383 | 0.383 | 0.383 | 0.383 |
| coordinates | y | 0.380 | 0.380 | 0.380 | 0.380 |
| Relative luminous flux (%) | | 101.0 | 102.1 | 100.0 | 99.0 |
| Color rendering | Ra | 87 | 84 | 83 | 92 |
| index | R9 | 65 | 70 | 8 | 90 |
| | R15 | 89 | 90 | 75 | 98 |

| | | | | |
|---|---|---|---|---|
| First intensity ratio I₅₀₀ | 0.37 | 0.23 | 0.54 | 0.53 |
| Second intensity ratio I₆₀₀ | 0.85 | 0.77 | 1.27 | 0.82 |

The light emitting device according to each of Examples 8 and 9 emitted a mixed color light having a correlated color temperature of around 4,000 K, an average color rendering index Ra of 80 or more, a special color rendering index R9 of 50 or more, and a special color rendering index R15 of 80 or more. The light emitting device according to each of Examples 8 and 9 had a first light emission intensity ratio I₅₀₀ of 0.01 or more and 0.50 or less, and a second light emission intensity ratio I₆₀₀ of 0.10 or more and 0.98 or less. The light emitting device according to each of Examples 8 and 9 had a luminous flux higher than that of the light emitting device according to each of Comparative Examples 7 and 8. A light emitting device containing the same first fluorescent material as that of the light emitting device according to Example 9, and containing a KSF having a composition included in the compositional formula represented by the formula (2) as the second fluorescent material, instead of the KSAF having a composition included in the compositional formula represented by the formula (1), is presumed to have a target correlation color temperature of 4,000 K as in Example 9, and approximately the same relative luminous flux, average color rendering index Ra, special color change index R9, first light emission intensity ratio I₅₀₀, and second light emission intensity ratio I₆₀₀ as those of the light emitting device according to Example 9 even when the correlated color temperature is around 4,000 K, and is presumed to emit light having a high color rendering index and a high luminous flux. A light emitting device containing the same first and third fluorescent materials as those of the light emitting device according to Example 8, and containing a KSF having a composition included in the compositional formula represented by the formula (2) as the second fluorescent material, instead of the KSAF having a composition included in the compositional formula represented by the formula (1), is presumed to have a target correlation color temperature of 4,000 K as in Example 8, and approximately the same relative luminous flux, average color rendering index Ra, special color change index R9, first light emission intensity ratio I₅₀₀, and second light emission intensity ratio I₆₀₀ as those of the light emitting device according to Example 8 even when the correlated color temperature is around 4,000 K, and is presumed to emit light having a high color rendering index and a high luminous flux.

The light emitting device according to Comparative Example 7 did not contain a second fluorescent material in the fluorescent member, and had a special color rendering index R9 representing the color red of less than 50 and a special color rendering index R15 of less than 80. The light emitting device according to each of Comparative Examples 7 and 8 had a first light emission intensity ratio I₅₀₀ of more than 0.50, and a second light emission intensity ratio I₆₀₀ of more than 0.98. The light emitting device according to Comparative Example 8 had a first light emission intensity ratio I₅₀₀ of more than 0.50, and a high color rendering index, with an average color rendering index Ra of more than 90 and a special color rendering index R9 of 90, but a low relative luminous flux.

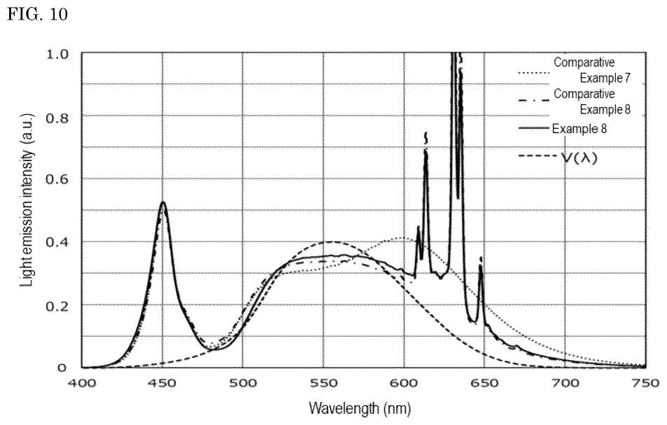

FIG. 10 is a graph showing light emission spectra of the light emitting devices according to Example 8 and Comparative Examples 7 and 8, and a spectral luminous efficiency curve V (λ) for photopic vision of humans. The light emitting device according to Example 8 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 7 and 8, at 555 nm, which is the peak sensitivity wavelength of the spectral luminous efficiency curve for photopic vision of humans.

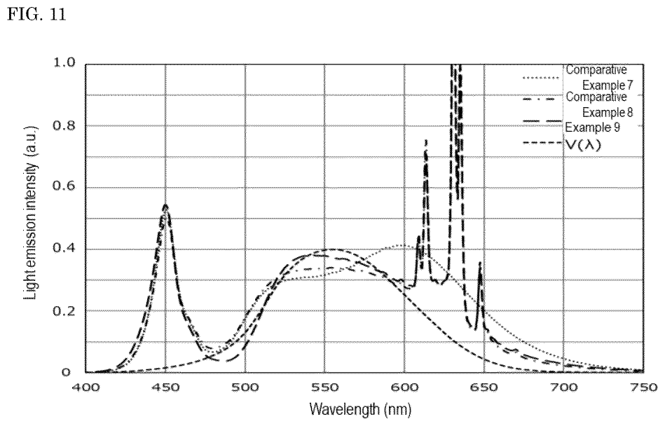

FIG. 11 is a graph showing light emission spectra of the light emitting devices according to Example 9 and Comparative Examples 7 and 8, and a spectral luminous efficiency curve V (λ) for photopic vision of humans. The light emitting device according to Example 9 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 7 and 8, at 555 nm, which is the peak sensitivity wavelength of the spectral luminous efficiency curve for photopic vision of humans.

### Examples 10 and 11

A light emitting element having a light emission peak wavelength of 450 nm and a fluorescent member composition containing a first fluorescent material, a second fluorescent material, and optionally a third fluorescent material listed in Table 8 so as to have a correlated color temperature of around 5,000 K, and containing a silicone resin, were prepared. The total amount of the first fluorescent material, the second fluorescent material, and optionally the third fluorescent material relative to 100 parts by mass of the silicone resin is shown in Table 7 as the blending amount (parts by mass) of the fluorescent materials relative to 100 parts by mass of the resin. The content ratio (% by mass) of each fluorescent material relative to the total amount of the fluorescent materials being 100% by mass, and the amount (parts by mass) of the second fluorescent material relative to the total amount of the second fluorescent material and the third fluorescent material being 100 parts by mass, are also shown in Table 8.

A light emitting device shown in FIG. 1 was produced. Specifically, a light emitting device was produced in the same or similar manner as in Example 1, except that a fluorescent member composition shown in Table 8 was used.

### Comparative Example 9

A light emitting device was produced in the same or similar manner as in Example 10, except that a fluorescent member composition containing no second fluorescent material, and containing a first fluorescent material and a third fluorescent material listed in Table 8, was used.

### Comparative Example 10

A light emitting device was produced in the same or similar manner as in Example 10, except that a fluorescent member composition containing a first fluorescent material, a second fluorescent material, and a third fluorescent material listed in Table 8, was used.

TABLE 8

| | | | | Comparative | Comparative |
|---|---|---|---|---|---|
| | | Example 10 | Example 11 | Example 9 | Example 10 |
| Fluorescent | First fluorescent | G-YAG2/YAG1 | G-YAG2/YAG1 | G-YAG1/G-YAG3 | G-YAG2/YAG1 |
| materials | material | (55/45) | (20/80) | (85/15) | (80/20) |
| | Second fluorescent | KSAF | KSAF | — | KSAF |
| | material | | | | |
| | Third fluorescent | SCASN1 | — | SCASN2 | SCASN1 |
| | material | | | | |
| Blending amount of fluorescent | | 72.1 | 90.5 | 45.0 | 85.9 |
| materials relative to 100 parts | | | | | |
| by mass of resin (parts by mass) | | | | | |
| Content ratio in | First fluorescent | 66.7 | 64.0 | 95.9 | 60.1 |
| total fluorescent | material | | | | |
| material amount | Second fluorescent | 32.3 | 36.0 | — | 38.7 |
| (% by mass) | material | | | | |
| | Third fluorescent | 1.0 | — | 4.1 | 1.2 |
| | material | | | | |
| Second fluorescent material/ | | 97.0 | 100.0 | 0.0 | 97.0 |
| (second fluorescent material + | | | | | |
| third fluorescent material) | | | | | |
| (parts by mass) | | | | | |
| Correlated color temperature (K) | | 4983 | 4984 | 4996 | 4986 |
| Chromaticity | x | 0.345 | 0.345 | 0.345 | 0.345 |
| coordinates | y | 0.355 | 0.355 | 0.355 | 0.355 |
| Relative luminous flux (%) | | 101.0 | 102.4 | 100.0 | 98.7 |
| Color rendering | Ra | 86 | 85 | 85 | 91 |
| index | R9 | 59 | 69 | 16 | 81 |
| | R15 | 86 | 90 | 78 | 94 |

| | | | | |
|---|---|---|---|---|
| First intensity ratio I₅₀₀ | 0.49 | 0.39 | 0.70 | 0.61 |
| Second intensity ratio I₆₀₀ | 0.77 | 0.71 | 1.10 | 0.74 |

The light emitting device according to each of Examples 10 and 11 emitted a mixed color light having a correlated color temperature of around 5,000 K, an average color rendering index Ra of 80 or more, a special color rendering index R9 of 50 or more, and a special color rendering index R15 of 80 or more. The light emitting device according to each of Examples 10 and 11 had a first light emission intensity ratio I₅₀₀ of 0.01 or more and 0.55 or less, and a second light emission intensity ratio I₆₀₀ of 0.10 or more and 0.90 or less. The light emitting device according to each of Examples 10 and 11 had a luminous flux higher than that of the light emitting device according to each of Comparative Examples 9 and 10. A light emitting device containing the same first fluorescent material as that of the light emitting device according to Example 11, and containing a KSF having a composition included in the compositional formula represented by the formula (2) as the second fluorescent material, instead of the KSAF having a composition included in the compositional formula represented by the formula (1), is presumed to have a target correlation color temperature of 5,000 K as in Example 11, and approximately the same relative luminous flux, average color rendering index Ra, special color change index R9, first light emission intensity ratio I₅₀₀, and second light emission intensity ratio I₆₀₀ as those of the light emitting device according to Example 11 even when the correlated color temperature is around 5,000 K, and is presumed to emit light having a high color rendering index and a high luminous flux. A light emitting device containing the same first and third fluorescent materials as those of the light emitting device according to Example 10, and containing a KSF having a composition included in the compositional formula represented by the formula (2) as the second fluorescent material, instead of the KSAF having a composition included in the compositional formula represented by the formula (1), is presumed to have a target correlation color temperature of 5,000 K as in Example 10, and approximately the same relative luminous flux, average color rendering index Ra, special color change index R9, first light emission intensity ratio I₅₀₀, and second light emission intensity ratio I₆₀₀ as those of the light emitting device according to Example 10 even when the correlated color temperature is around 5,000 K, and is presumed to emit light having a high color rendering index and a high luminous flux.

The light emitting device according to Comparative Example 9 did not contain a second fluorescent material in the fluorescent member, and had a special color rendering index R9 representing the color red of less than 50 and a special color rendering index R15 of less than 80. The light emitting device according to Comparative Example 9 had a first light emission intensity ratio I₅₀₀ of more than 0.55, and a second light emission intensity ratio I₆₀₀ of more than 0.90. The light emitting device according to Comparative Example 10 had a first light emission intensity ratio I₅₀₀ of more than 0.55, and a high color rendering index, with an average color rendering index Ra of 90 or more and a special color rendering index R9 of 80 or more, but a low relative luminous flux.

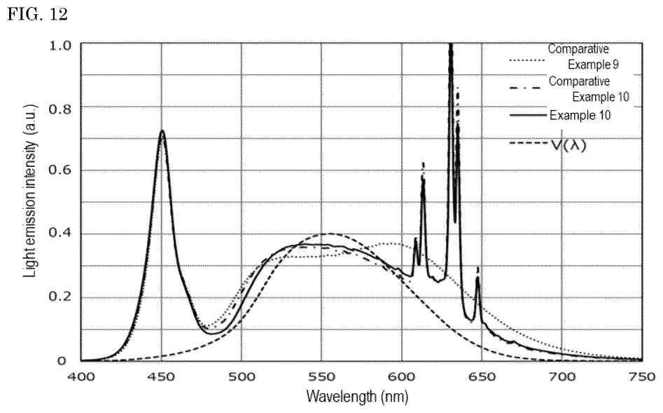

FIG. 12 is a graph showing light emission spectra of the light emitting devices according to Example 10 and Comparative Examples 9 and 10, and a spectral luminous efficiency curve V (λ) for photopic vision of humans. The light emitting device according to Example 10 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 9 and 10, at 555 nm, which is the peak sensitivity wavelength of the spectral luminous efficiency curve for photopic vision of humans.

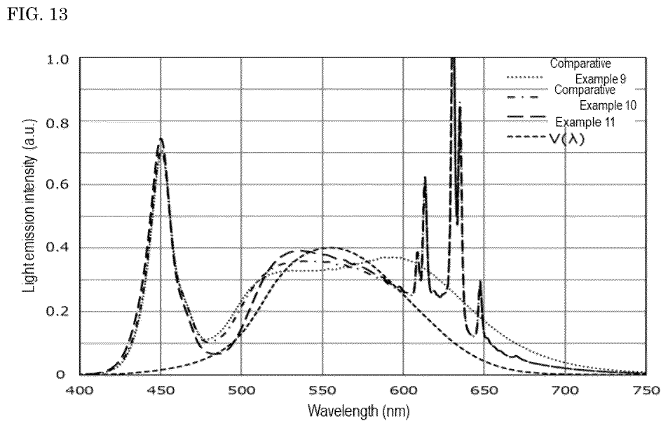

FIG. 13 is a graph showing light emission spectra of the light emitting devices according to Example 11 and Comparative Examples 9 and 10, and a spectral luminous efficiency curve V (λ) for photopic vision of humans. The light emitting device according to Example 11 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 9 and 10, at 555 nm, which is the peak sensitivity wavelength of the spectral luminous efficiency curve for photopic vision of humans.

### Examples 12 and 13

A light emitting element having a light emission peak wavelength of 450 nm and a fluorescent member composition containing a first fluorescent material, a second fluorescent material, and optionally a third fluorescent material listed in Table 9 so as to have a correlated color temperature of around 6,500 K, and containing a silicone resin, were prepared. The total amount of the first fluorescent material, the second fluorescent material, and optionally the third fluorescent material relative to 100 parts by mass of the silicone resin is shown in Table 7 as the blending amount (parts by mass) of the fluorescent materials relative to 100 parts by mass of the resin. The content ratio (% by mass) of each fluorescent material relative to the total amount of the fluorescent materials being 100% by mass, and the amount (parts by mass) of the second fluorescent material relative to the total amount of the second fluorescent material and the third fluorescent material being 100 parts by mass, are also shown in Table 9.

A light emitting device shown in FIG. 1 was produced. Specifically, a light emitting device was produced in the same or similar manner as in Example 1, except that a fluorescent member composition shown in Table 9 was used.

### Comparative Example 11

A light emitting device was produced in the same or similar manner as in Example 12, except that a fluorescent member composition, containing no second fluorescent material and containing a first fluorescent material and a third fluorescent material listed in Table 9, was used.

### Comparative Example 12

A light emitting device was produced in the same or similar manner as in Example 12, except that a fluorescent member composition containing a first fluorescent material, a second fluorescent material, and a third fluorescent material listed in Table 9, was used.

### Example 15

A light emitting device was produced in the same or similar manner as in Example 12, except that a fluorescent member composition containing a first fluorescent material and a second fluorescent material listed in Table 9, was used.

TABLE 9

| | | | | | Comparative | Comparative |
|---|---|---|---|---|---|---|
| | | Example 12 | Example 13 | Example 15 | Example 11 | Example 12 |
| Fluorescent | First | G-YAG2/ | G-YAG2/ | G-YAG2/ | LAG2 | G-YAG2 |
| materials | fluorescent | YAG1 | YAG1 | YAG1 | | |
| | material | (50/50) | (55/45) | (55/45) | | |
| | Second | KSAF | KSAF | KSF | — | KSAF |
| | fluorescent | | | | | |
| | material | | | | | |
| | Third | SCASN1 | — | — | SCASN2 | SCASN1 |
| | fluorescent | | | | | |
| | material | | | | | |
| Blending amount of | | 50.0 | 52.8 | 58.8 | 36.8 | 57.1 |
| fluorescent materials | | | | | | |
| relative to 100 parts | | | | | | |
| by mass of resin | | | | | | |
| (parts by mass) | | | | | | |
| Content ratio in | First | 76.6 | 73.6 | 72.4 | 96.3 | 68.4 |
| total fluorescent | fluorescent | | | | | |
| material amount | material | | | | | |
| (% by mass) | Second | 22.7 | 26.4 | 27.6 | — | 30.7 |
| | fluorescent | | | | | |
| | material | | | | | |
| | Third | 0.7 | — | — | 3.7 | 0.9 |
| | fluorescent | | | | | |
| | material | | | | | |
| Second fluorescent material/ | | 97.0 | 100.0 | 100.0 | 0.0 | 97.0 |
| (second fluorescent material + | | | | | | |
| third fluorescent material) | | | | | | |
| (parts by mass) | | | | | | |
| Correlated color | | 6497 | 6525 | 6514 | 6523 | 6514 |
| temperature (K) | | | | | | |
| Chromaticity | x | 0.312 | 0.312 | 0.312 | 0.312 | 0.312 |
| coordinates | y | 0.328 | 0.328 | 0.328 | 0.328 | 0.328 |
| Relative luminous flux (%) | | 102.6 | 101.5 | 101.2 | 100.0 | 99.1 |
| Color rendering | Ra | 84 | 85 | 85 | 85 | 91 |
| index | R9 | 79 | 65 | 57 | 15 | 80 |
| | R15 | 85 | 89 | 90 | 80 | 95 |

| | | | | | |
|---|---|---|---|---|---|
| First intensity ratio I₅₀₀ | 0.54 | 0.56 | 0.56 | 0.79 | 0.77 |
| Second intensity ratio I₆₀₀ | 0.69 | 0.65 | 0.65 | 0.94 | 0.87 |

The light emitting device according to each of Examples 12, 13, and 15 emitted a mixed color light having a correlated color temperature of around 6,500 K, an average color rendering index Ra of 80 or more, a special color rendering index R9 of 50 or more, and a special color rendering index R15 of 80 or more. The light emitting device according to each of Examples 12, 13, and 15 had a first light emission intensity ratio I₅₀₀ of 0.01 or more and 0.70 or less, and a second light emission intensity ratio I₆₀₀ of 0.10 or more and 0.90 or less. The light emitting device according to each of Examples 12, 13, and 15 had a luminous flux higher than that of the light emitting device according to each of Comparative Examples 11 and 12. The light emitting device according to Example 15 containing the same first fluorescent material as that of the light emitting device according to Example 13, and containing a KSF having a composition included in the compositional formula represented by the formula (2) as the second fluorescent material, instead of the KSAF having a composition included in the compositional formula represented by the formula (1), has a target correlation color temperature of 6,500 K as in Example 13, and approximately the same relative luminous flux, average color rendering index Ra, special color change index R9, first light emission intensity ratio I₅₀₀, and second light emission intensity ratio I₆₀₀ as those of the light emitting device according to Example 13 even when the correlated color temperature is around 6,500 K, and emits light having a high color rendering index and a high luminous flux. A light emitting device containing the same first and third fluorescent materials as those of the light emitting device according to Example 12, and containing a KSF having a composition included in the compositional formula represented by the formula (2) as the second fluorescent material, instead of the KSAF having a composition included in the compositional formula represented by the formula (1), is presumed to have a target correlation color temperature of 6,500 K as in Example 12, and approximately the same relative luminous flux, average color rendering index Ra, special color change index R9, first light emission intensity ratio I₅₀₀, and second light emission intensity ratio I₆₀₀ as those of the light emitting device according to Example 12 even when the correlated color temperature is around 6,500 K, and is presumed to emit light having a high color rendering index and a high luminous flux.

The light emitting device according to Comparative Example 11 did not contain a second fluorescent material in the fluorescent member, and had a special color rendering index R9 representing the color red of less than 50 and a special color rendering index R15 of 80. The light emitting device according to each of Comparative Examples 11 and 12 had a first light emission intensity ratio I₅₀₀ of more than 0.70. The light emitting device according to Comparative Examples 11 had a second light emission intensity ratio I₆₀₀ of more than 0.90. The light emitting device according to Comparative Example 12 had a first light emission intensity ratio I₅₀₀ of more than 0.7, and a high color rendering index, with an average color rendering index Ra of more than 90 and a special color rendering index R9 of 70 or more, but a low relative luminous flux.

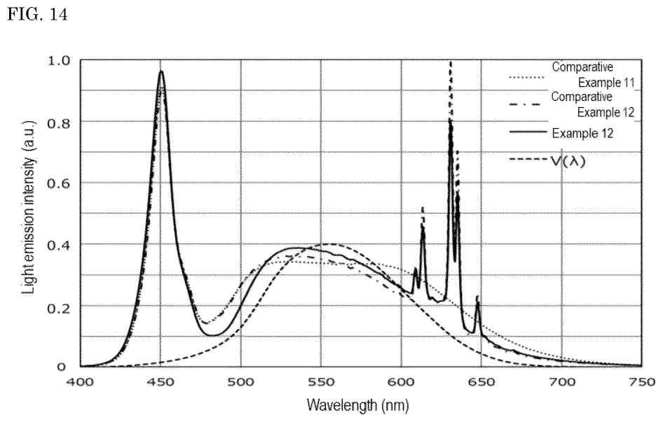

FIG. 14 is a graph showing light emission spectra of the light emitting devices according to Example 12 and Comparative Examples 11 and 12, and a spectral luminous efficiency curve V (λ) for photopic vision of humans. The light emitting device according to Example 12 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 11 and 12, at 555 nm, which is the peak sensitivity wavelength of the spectral luminous efficiency curve for photopic vision of humans.

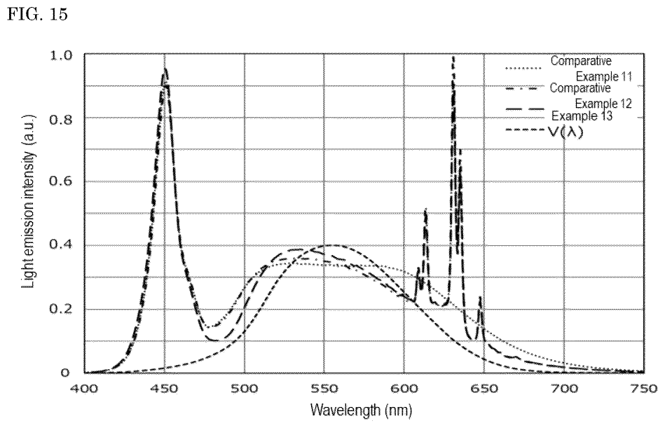

FIG. 15 is a graph showing light emission spectra of the light emitting devices according to Example 13 and Comparative Examples 11 and 12, and a spectral luminous efficiency curve V (λ) for photopic vision of humans. The light emitting device according to Example 13 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 11 and 12, at 555 nm, which is the peak sensitivity wavelength of the spectral luminous efficiency curve for photopic vision of humans.

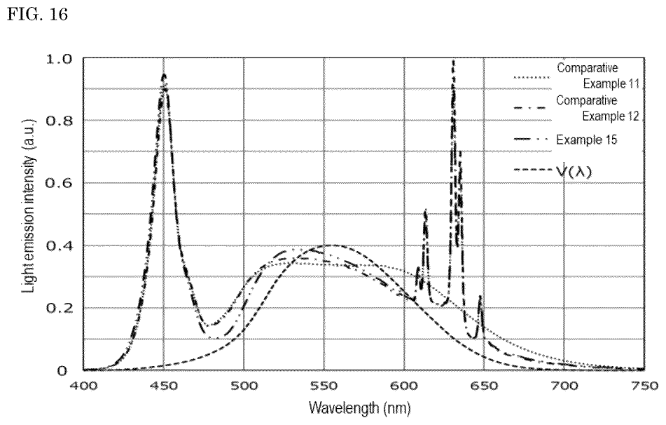

FIG. 16 is a graph showing light emission spectra of the light emitting devices according to Example 15 and Comparative Examples 11 and 12, and a spectral luminous efficiency curve V (λ) for photopic vision of humans. The light emitting device according to Example 15 resulted in a high luminous flux because the light emission spectrum thereof contained more of the component defined by the spectral luminous efficiency curve V (λ) for photopic vision of humans, compared to that of the light emission spectrum of the light emitting device according to each of Comparative Examples 11 and 12, at 555 nm, which is the peak sensitivity wavelength of the spectral luminous efficiency curve for photopic vision of humans.

### INDUSTRIAL APPLICABILITY

The light emitting device and the illumination device according to the present disclosure can be used for general indoor lighting, outdoor lighting, indirect lighting, on-vehicle lighting, and other applications.

### DENOTATIONS OF CHARACTERS AND NUMERALS

10: Light emitting element, 20: First lead, 30: Second lead, 40: Molded body, 42: Resin portion, 50: Fluorescent member, 60: Wire, 70: Fluorescent material, 71: First fluorescent material, 72: Second fluorescent material, 73: Third fluorescent material, 100: Light emitting device.

What is claimed is:

1.-13. (canceled)

14. A light emitting device comprising
a light emitting element having a light emission peak wavelength of 430 nm or more and 470 nm or less, and
a fluorescent member containing
a first fluorescent material having a light emission peak wavelength of 510 nm or more and less than 590 nm and
a second fluorescent material having a light emission peak wavelength of 590 nm or more and 670 nm or less and containing a first fluoride fluorescent material having a composition included in the compositional formula represented by the following formula (1): 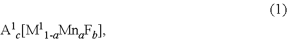
wherein A¹ includes at least K and optionally at least one element selected from the group consisting of Li, Na, Rb, and Cs, M¹ includes at least Si and Al and optionally at least one element selected from the group consisting of Group 4 elements, Group 13 elements, and Group 14 elements, a and b satisfy 0<a<0.2 and 5<b<7, and c represents the absolute value of the charge of [M¹₁₋ₐMnₐF_{b}] ions, and
wherein the light emitting device satisfies the following condition (A) or (B):
the condition (A) is that an average color rendering index Ra of light emitted from the light emitting device is 80 or more and 90 or less, and a color rendering index R9 thereof is 50 or more and 90 or less; and
the condition (B) is that an average color rendering index Ra of light emitted from the light emitting device is 80 or more and 87 or less, and a color rendering index R9 thereof is 50 or more.

15. A light emitting device comprising
a light emitting element having a light emission peak wavelength of 430 nm or more and 470 nm or less, and
a fluorescent member containing
a first fluorescent material having a light emission peak wavelength of 510 nm or more and less than 590 nm,
a second fluorescent material having a light emission peak wavelength of 590 nm or more and 670 nm or less and containing at least one fluoride fluorescent material selected from the group consisting of a first fluoride fluorescent material having a composition included in the compositional formula represented by the following formula (1) and a second fluoride fluorescent material having a composition included in the compositional formula represented by the following formula (2), and
a third fluorescent material containing at least one nitride fluorescent material selected from the group consisting of a first nitride fluorescent material having a composition included in the compositional formula represented by the following formula (3) and a second nitride fluorescent material having a composition included in the compositional formula represented by the following formula (4): 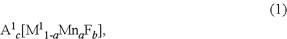
wherein A¹ includes at least K and optionally at least one element selected from the group consisting of Li, Na, Rb, and Cs, M¹ includes at least Si and Al and optionally at least one element selected from the group consisting of Group 4 elements, Group 13 elements, and Group 14 elements, a and b satisfy 0<a<0.2 and 5<b<7, and c represents the absolute value of the charge of [M¹₁₋ₐMnₐF_{b}] ions; 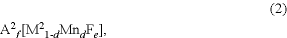
wherein A² includes at least one element selected from the group consisting of Li, Na, K, Rb, and Cs, M² includes at least one of Si and Ge and optionally at least one element selected from the group consisting of Group 4 elements and Group 14 elements, d and e satisfy 0<d<0.2 and 5<e<7, and f represents the absolute value of the charge of [M²_{1-d}Mn_{d}Fₑ] ions; 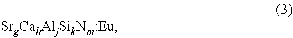
wherein g, h, j, k, and m satisfy 0≤g<1, 0<h≤1, g+h≤1, 0.9≤j≤1.1, 0.9≤k≤1.1, and 2.5≤m≤3.5; and 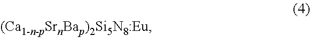
wherein n and p satisfy 0≤n<1.0 and 0≤p≤1.0, and
wherein the light emitting device satisfies the following condition (C):
the condition (C) is that an average color rendering index Ra of light emitted from the light emitting device is 80 or more and 90 or less, and a special color rendering index R9 thereof is 50 or more.

16. The light emitting device according to claim 14, wherein the light emitting device has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi):
(i) when the correlated color temperature is 2,000 K or more and less than 2,800 K, the first light emission intensity ratio I₅₀₀ is 0.01 or more and 0.15 or less;
(ii) when the correlated color temperature is 2,800 K or more and less than 3,300 K, the first light emission intensity ratio I₅₀₀ is 0.01 or more and 0.35 or less;
(iii) when the correlated color temperature is 3,300 K or more and less than 3,700 K, the first light emission intensity ratio I₅₀₀ is 0.01 or more and 0.45 or less;
(iv) when the correlated color temperature is 3,700 K or more and less than 4,500 K, the first light emission intensity ratio I₅₀₀ is 0.01 or more and 0.50 or less;
(v) when the correlated color temperature is 4,500 K or more and less than 5,700 K, the first light emission intensity ratio I₅₀₀ is 0.01 or more and 0.55 or less; and
(vi) when the correlated color temperature is 5,700 K or more and 6,800 K or less, the first light emission intensity ratio I₅₀₀ is 0.01 or more and 0.70 or less.

17. The light emitting device according to claim 15, wherein the light emitting device has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi):
(i) when the correlated color temperature is 2,000 K or more and less than 2,800 K, the first light emission intensity ratio I₅₀₀ is 0.01 or more and 0.50 or less;
(ii) when the correlated color temperature is 2,800 K or more and less than 3,300 K, the first light emission intensity ratio I₅₀₀ is 0.01 or more and 0.39 or less;
(iii) when the correlated color temperature is 3,300 K or more and less than 3,700 K, the first light emission intensity ratio I₅₀₀ is 0.01 or more and 0.45 or less;
(iv) when the correlated color temperature is 3,700 K or more and less than 4,500 K, the first light emission intensity ratio I₅₀₀ is 0.01 or more and 0.50 or less;
(v) when the correlated color temperature is 4,500 K or more and less than 5,700 K, the first light emission intensity ratio I₅₀₀ is 0.01 or more and 0.55 or less; and
(vi) when the correlated color temperature is 5,700 K or more and 6,800 K or less, the first light emission intensity ratio I₅₀₀ is 0.01 or more and 0.70 or less.

18. A light emitting device comprising
a light emitting element having a light emission peak wavelength of 430 nm or more and 470 nm or less, and
a fluorescent member containing
a first fluorescent material having a light emission peak wavelength of 510 nm or more and less than 590 nm and
a second fluorescent material having a light emission peak wavelength of 590 nm or more and 670 nm or less and containing a second fluoride fluorescent material having a composition included in the compositional formula represented by the following formula (2): 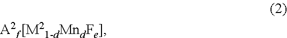
wherein A² includes at least one element selected from the group consisting of Li, Na, K, Rb, and Cs, M² includes at least one of Si and Ge and optionally at least one element selected from the group consisting of Group 4 elements and Group 14 elements, d and e satisfy 0<d<0.2 and 5<e<7, and f represents the absolute value of the charge of [M²_{1-d}Mn_{d}Fₑ] ions,
wherein the light emitting device satisfies the following condition (A′) or (B):
the condition (A′) is that an average color rendering index Ra of light emitted from the light emitting device is 80 or more, and a color rendering index R9 thereof is 50 or more and 70 or less; and
the condition (B) is that an average color rendering index Ra of light emitted from the light emitting device is 80 or more and 87 or less, and a special color rendering index R9 thereof is 50 or more, and
wherein the light emitting device has a light emission spectrum in which, when a correlated color temperature of light emitted from the light emitting device is in a range described in any one of the following (i) to (vi), a first light emission intensity ratio I₅₀₀ of a light emission intensity at a wavelength of 500 nm to a light emission intensity at a wavelength of 555 nm is in a range described in the corresponding one of the following (i) to (vi):
(i) when the correlated color temperature is 2,000 K or more and less than 2,800 K, the first light emission intensity ratio I₅₀₀ is 0.01 or more and 0.15 or less;
(ii) when the correlated color temperature is 2,800 K or more and less than 3,300 K, the first light emission intensity ratio I₅₀₀ is 0.01 or more and 0.35 or less;
(iii) when the correlated color temperature is 3,300 K or more and less than 3,700 K, the first light emission intensity ratio I₅₀₀ is 0.01 or more and 0.45 or less;
(iv) when the correlated color temperature is 3,700 K or more and less than 4,500 K, the first light emission intensity ratio I₅₀₀ is 0.01 or more and 0.50 or less;
(v) when the correlated color temperature is 4,500 K or more and less than 5,700 K, the first light emission intensity ratio I₅₀₀ is 0.01 or more and 0.55 or less; and
(vi) when the correlated color temperature is 5,700 K or more and 6,800 K or less, the first light emission intensity ratio I₅₀₀ is 0.01 or more and 0.70 or less.

19. The light emitting device according to claim 14, wherein the light emitting device has a light emission spectrum in which, when a correlated color temperature of light emitted from the light emitting device is in a range described in any one of the following (vii) to (x), a second light emission intensity ratio I₆₀₀ of a light emission intensity at a wavelength of 600 nm to a light emission intensity at a wavelength of 555 nm is in a range described in the corresponding one of the following (vii) to (x):
(vii) when the correlated color temperature is 2,000 K or more and less than 2,800 K, the second light emission intensity ratio I₆₀₀ is 0.10 or more and 0.92 or less;
(viii) when the correlated color temperature is 2,800 K or more and less than 3,300 K, the second light emission intensity ratio I₆₀₀ is 0.10 or more and 0.87 or less;
(ix) when the correlated color temperature is 3,300 K or more and less than 4,500 K, the second light emission intensity ratio I₆₀₀ is 0.10 or more and 0.98 or less; and
(x) when the correlated color temperature is 4,500 K or more and 6,800 K or less, the second light emission intensity ratio I₆₀₀ is 0.10 or more and 0.90 or less.

20. The light emitting device according to claim 16, wherein the light emitting device has a light emission spectrum in which, when a correlated color temperature of light emitted from the light emitting device is in a range described in any one of the following (vii) to (x), a second light emission intensity ratio I₆₀₀ of a light emission intensity at a wavelength of 600 nm to a light emission intensity at a wavelength of 555 nm is in a range described in the corresponding one of the following (vii) to (x):
(vii) when the correlated color temperature is 2,000 K or more and less than 2,800 K, the second light emission intensity ratio I₆₀₀ is 0.10 or more and 0.92 or less;
(viii) when the correlated color temperature is 2,800 K or more and less than 3,300 K, the second light emission intensity ratio I₆₀₀ is 0.10 or more and 0.87 or less;
(ix) when the correlated color temperature is 3,300 K or more and less than 4,500 K, the second light emission intensity ratio I₆₀₀ is 0.10 or more and 0.98 or less; and
(x) when the correlated color temperature is 4,500 K or more and 6,800 K or less, the second light emission intensity ratio I₆₀₀ is 0.10 or more and 0.90 or less.

21. The light emitting device according to claim 18, wherein the light emitting device has a light emission spectrum in which, when a correlated color temperature of light emitted from the light emitting device is in a range described in any one of the following (vii) to (x), a second light emission intensity ratio I₆₀₀ of a light emission intensity at a wavelength of 600 nm to a light emission intensity at a wavelength of 555 nm is in a range described in the corresponding one of the following (vii) to (x):
(vii) when the correlated color temperature is 2,000 K or more and less than 2,800 K, the second light emission intensity ratio I₆₀₀ is 0.10 or more and 0.92 or less;
(viii) when the correlated color temperature is 2,800 K or more and less than 3,300 K, the second light emission intensity ratio I₆₀₀ is 0.10 or more and 0.87 or less;
(ix) when the correlated color temperature is 3,300 K or more and less than 4,500 K, the second light emission intensity ratio I₆₀₀ is 0.10 or more and 0.98 or less; and
(x) when the correlated color temperature is 4,500 K or more and 6,800 K or less, the second light emission intensity ratio I₆₀₀ is 0.10 or more and 0.90 or less.

22. The light emitting device according to claim 15, wherein the light emitting device has a light emission spectrum in which, when a correlated color temperature of light emitted from the light emitting device is in a range described in any one of the following (vii) to (x), a second light emission intensity ratio I₆₀₀ of a light emission intensity at a wavelength of 600 nm to a light emission intensity at a wavelength of 555 nm is in a range described in the corresponding one of the following (vii) to (x):
(vii) when the correlated color temperature is 2,000 K or more and less than 2,800 K, the second light emission intensity ratio I₆₀₀ is 0.10 or more and 1.34 or less;
(viii) when the correlated color temperature is 2,800 K or more and less than 3,300 K, the second light emission intensity ratio I₆₀₀ is 0.10 or more and 1.09 or less;
(ix) when the correlated color temperature is 3,300 K or more and less than 4,500 K, the second light emission intensity ratio I₆₀₀ is 0.10 or more and 0.98 or less; and
(x) when the correlated color temperature is 4,500 K or more and 6,800 K or less, the second light emission intensity ratio I₆₀₀ is 0.10 or more and 0.90 or less.

23. The light emitting device according to claim 17, wherein the light emitting device has a light emission spectrum in which, when a correlated color temperature of light emitted from the light emitting device is in a range described in any one of the following (vii) to (x), a second light emission intensity ratio I₆₀₀ of a light emission intensity at a wavelength of 600 nm to a light emission intensity at a wavelength of 555 nm is in a range described in the corresponding one of the following (vii) to (x):
(vii) when the correlated color temperature is 2,000 K or more and less than 2,800 K, the second light emission intensity ratio I₆₀₀ is 0.10 or more and 1.34 or less;
(viii) when the correlated color temperature is 2,800 K or more and less than 3,300 K, the second light emission intensity ratio I₆₀₀ is 0.10 or more and 1.09 or less;
(ix) when the correlated color temperature is 3,300 K or more and less than 4,500 K, the second light emission intensity ratio I₆₀₀ is 0.10 or more and 0.98 or less; and
(x) when the correlated color temperature is 4,500 K or more and 6,800 K or less, the second light emission intensity ratio I₆₀₀ is 0.10 or more and 0.90 or less.

24. The light emitting device according to claim 14, wherein, when a correlated color temperature of light emitted from the light emitting device is in a range described in any one of the following (i) to (vi), the first fluorescent material that emits light when absorbing the light emitted from the light emitting element has a light emission peak wavelength in a range described in the corresponding one of the following (i) to (vi):
(i) when the correlated color temperature is 2,000 K or more and less than 2,800 K, the light emission peak wavelength of the first fluorescent material is 558 nm or more and 578 nm or less;
(ii) when the correlated color temperature is 2,800 K or more and less than 3,300 K, the light emission peak wavelength of the first fluorescent material is 555 nm or more and 575 nm or less;
(iii) when the correlated color temperature is 3,300 K or more and less than 3,700 K, the light emission peak wavelength of the first fluorescent material is 552 nm or more and 572 nm or less;
(iv) when the correlated color temperature is 3,700 K or more and less than 4,500 K, the light emission peak wavelength of the first fluorescent material is 547 nm or more and 567 nm or less;
(v) when the correlated color temperature is 4,500 K or more and less than 5,700 K, the light emission peak wavelength of the first fluorescent material is 538 nm or more and 558 nm or less; and
(vi) when the correlated color temperature is 5,700 K or more and 6,800 K or less, the light emission peak wavelength of the first fluorescent material is 533 nm or more and 553 nm or less.

25. The light emitting device according to claim 16, wherein, when a correlated color temperature of light emitted from the light emitting device is in a range described in any one of the following (i) to (vi), the first fluorescent material that emits light when absorbing the light emitted from the light emitting element has a light emission peak wavelength in a range described in the corresponding one of the following (i) to (vi):
(i) when the correlated color temperature is 2,000 K or more and less than 2,800 K, the light emission peak wavelength of the first fluorescent material is 558 nm or more and 578 nm or less;
(ii) when the correlated color temperature is 2,800 K or more and less than 3,300 K, the light emission peak wavelength of the first fluorescent material is 555 nm or more and 575 nm or less;
(iii) when the correlated color temperature is 3,300 K or more and less than 3,700 K, the light emission peak wavelength of the first fluorescent material is 552 nm or more and 572 nm or less;
(iv) when the correlated color temperature is 3,700 K or more and less than 4,500 K, the light emission peak wavelength of the first fluorescent material is 547 nm or more and 567 nm or less;
(v) when the correlated color temperature is 4,500 K or more and less than 5,700 K, the light emission peak wavelength of the first fluorescent material is 538 nm or more and 558 nm or less; and
(vi) when the correlated color temperature is 5,700 K or more and 6,800 K or less, the light emission peak wavelength of the first fluorescent material is 533 nm or more and 553 nm or less.

26. The light emitting device according to claim 18, wherein, when a correlated color temperature of light emitted from the light emitting device is in a range described in any one of the following (i) to (vi), the first fluorescent material that emits light when absorbing the light emitted from the light emitting element has a light emission peak wavelength in a range described in the corresponding one of the following (i) to (vi):
(i) when the correlated color temperature is 2,000 K or more and less than 2,800 K, the light emission peak wavelength of the first fluorescent material is 558 nm or more and 578 nm or less;
(ii) when the correlated color temperature is 2,800 K or more and less than 3,300 K, the light emission peak wavelength of the first fluorescent material is 555 nm or more and 575 nm or less;
(iii) when the correlated color temperature is 3,300 K or more and less than 3,700 K, the light emission peak wavelength of the first fluorescent material is 552 nm or more and 572 nm or less;
(iv) when the correlated color temperature is 3,700 K or more and less than 4,500 K, the light emission peak wavelength of the first fluorescent material is 547 nm or more and 567 nm or less;
(v) when the correlated color temperature is 4,500 K or more and less than 5,700 K, the light emission peak wavelength of the first fluorescent material is 538 nm or more and 558 nm or less; and
(vi) when the correlated color temperature is 5,700 K or more and 6,800 K or less, the light emission peak wavelength of the first fluorescent material is 533 nm or more and 553 nm or less.

27. The light emitting device according to claim 15, wherein, when a correlated color temperature of light emitted from the light emitting device is in a range described in any one of the following (i) to (vi), the first fluorescent material that emits light when absorbing the light emitted from the light emitting element has a light emission peak wavelength in a range described in the corresponding one of the following (i) to (vi):
(i) when the correlated color temperature is 2,000 K or more and less than 2,800 K, the light emission peak wavelength of the first fluorescent material is 539 nm or more and 559 nm or less;
(ii) when the correlated color temperature is 2,800 K or more and less than 3,300 K, the light emission peak wavelength of the first fluorescent material is 540 nm or more and 560 nm or less;
(iii) when the correlated color temperature is 3,300 K or more and less than 3,700 K, the light emission peak wavelength of the first fluorescent material is 540 nm or more and 560 nm or less;
(iv) when the correlated color temperature is 3,700 K or more and less than 4,500 K, the light emission peak wavelength of the first fluorescent material is 536 nm or more and 556 nm or less;
(v) when the correlated color temperature is 4,500 K or more and less than 5,700 K, the light emission peak wavelength of the first fluorescent material is 533 nm or more and 553 nm or less; and
(vi) when the correlated color temperature is 5,700 K or more and 6,800 K or less, the light emission peak wavelength of the first fluorescent material is 534 nm or more and 554 nm or less.

28. The light emitting device according to claim 17, wherein, when a correlated color temperature of light emitted from the light emitting device is in a range described in any one of the following (i) to (vi), the first fluorescent material that emits light when absorbing the light emitted from the light emitting element has a light emission peak wavelength in a range described in the corresponding one of the following (i) to (vi):
(i) when the correlated color temperature is 2,000 K or more and less than 2,800 K, the light emission peak wavelength of the first fluorescent material is 539 nm or more and 559 nm or less;
(ii) when the correlated color temperature is 2,800 K or more and less than 3,300 K, the light emission peak wavelength of the first fluorescent material is 540 nm or more and 560 nm or less;
(iii) when the correlated color temperature is 3,300 K or more and less than 3,700 K, the light emission peak wavelength of the first fluorescent material is 540 nm or more and 560 nm or less;
(iv) when the correlated color temperature is 3,700 K or more and less than 4,500 K, the light emission peak wavelength of the first fluorescent material is 536 nm or more and 556 nm or less;
(v) when the correlated color temperature is 4,500 K or more and less than 5,700 K, the light emission peak wavelength of the first fluorescent material is 533 nm or more and 553 nm or less; and
(vi) when the correlated color temperature is 5,700 K or more and 6,800 K or less, the light emission peak wavelength of the first fluorescent material is 534 nm or more and 554 nm or less.

29. The light emitting device according to claim 15, wherein a content of the second fluorescent material relative to a total amount of the second and third fluorescent materials being 100 parts by mass in the fluorescent member is 86 parts by mass or more and 99.5 parts by mass or less.

30. The light emitting device according to claim 17, wherein a content of the second fluorescent material relative to a total amount of the second and third fluorescent materials being 100 parts by mass in the fluorescent member is 86 parts by mass or more and 99.5 parts by mass or less.

31. The light emitting device according to claim 14, wherein the first fluorescent material contains at least one selected from the group consisting of a rare earth aluminate fluorescent material having a composition included in the compositional formula represented by the following formula (5) and a third nitride fluorescent material having a composition included in the compositional formula represented by the following formula (6): 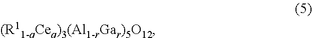
wherein R¹ represents at least one element selected from the group consisting of Y, Gd, Lu, and Tb, and q and r satisfy 0.001≤q≤0.20 and 0≤r<1.0; and 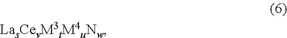
wherein M³ represents at least one selected from the group consisting of rare earth elements other than La and Ce, M⁴ represents at least one selected from the group consisting of Si, Ge, B, Al, and Ga, and includes at least Si, and s, t, u, v, and w satisfy 2.7≤s+t+v≤3.3, 0≤t≤1.2, 5.0≤u≤6.6, 0<v≤1.2, and 10≤w≤12.

32. The light emitting device according to claim 14, wherein the light emitted from the light emitting device has a special color rendering index R15 of 80 or more.

33. An illumination device comprising the light emitting device according to claim 14.
